(19) United States
(12) Patent Application Publication
(10) Pub. No.: US 2023/0206466 A1
(43) Pub. Date: Jun. 29, 2023

(54) SYSTEM AND METHOD FOR TRACKING AND IDENTIFYING MOVING OBJECTS

(71) Applicant: Everseen Limited, Blackpool (IE)

(72) Inventors: Ana Cristina Todoran, Arad (RO); Otniel-Bogdan Mercea, Arad (RO)

(21) Appl. No.: 17/562,364

(22) Filed: Dec. 27, 2021

(51) Int. Cl. G06T 7/215; G06T 7/207; G08G 1/017

(52) U.S. Cl. CPC G06T 7/215; G06T 7/207; G08G 1/0175; G06T 2207/20081; G06T 2207/20084; G06T 2207/30252

(57) ABSTRACT

A method for tracking and identifying vehicles is disclosed that includes detecting a vehicle in a current video frame of a video stream, establishing a bounding box around the detected vehicle, calculating a measurement vector of detected vehicle including horizontal and vertical locations of the centre of the bounding box at the current time instance, calculating a plurality of predicted measurement vectors for corresponding plurality of previously detected vehicles, based on current measurement vector and previous state vectors of previously detected vehicles, calculating a plurality of first cost values for previously detected vehicles based on a distance between the current measurement vector of the detected vehicle, and predicted measurement vectors, and identifying and storing the detected vehicle as a previously detected first vehicle, when the first cost value of the previously detected first vehicle is less than a first cost threshold.

### TECHNICAL FIELD

The present disclosure relates to tracking movements of an object, for instance, a vehicle moving in an environment that may induce the vehicle to undertake unpredictable and/or erratic movements. More specifically, the present disclosure relates to a system and method for tracking unpredictable motions of the vehicle including sudden stops, reversing operations and swerving motions in a drive-through facility.

### BACKGROUND

In recent times, social distancing has become an essential component as a routine, or as a protocol, to prevent the spread of communicable diseases. Especially, in customer-facing services, isolation of a customer from other customers and staff members may be needed to comply with one or more pandemic restriction measures that are put in place to prevent the spread of communicable diseases. For instance, while drive-through restaurant lanes have been used for decades as a driver of sales at fast food chains, demand for such facilities has increased lately owing to a closure of indoor dining restaurants where human to human interaction, or contact, is likely to occur. Drive-through arrangements use customer’s vehicles and their ordered progression along a road to effectively isolate customers from each other. Automation is also being increasingly used to further limit the likelihood of physical contact between human beings.

In these environments, slow service may become a significant customer deterrent. The throughput of a sequential linear system may be inherently limited by the speed of the slowest access operation. Stated differently, in a typical queuing system of a drive-through facility, speed of service to one or more members of the queue may be limited by the slowest member of the queue or any other member in the queue whose order is the slowest to fulfil. One way of mitigating the limitations of a linear sequential system is to allow multiple simultaneous access requests from different members of the queue. For example, in a given drive-through facility, rather than merely serving customers that are in vehicles at the top of the queue, the drive-through facility could also at the same time serve customers in other vehicles further down the queue so that the otherwise concomitant effect of knock-on delay can be reduced when the order for one or more vehicles at the top of the queue is slower than usual. To overcome the undesirable effects of knock-on delays, one or more solutions for serving customers in a drive-through facility may need to be automated for efficient tracking of each vehicle in the drive-through facility from the instant each vehicle enters the facility until the instant the vehicle leaves the drive-through facility.

Further, many drive-through facilities are co-located with a car park area that may include over-flow parking bays for customers of the drive-through facility and/or parking bays for customers shopping in shopping malls and the like. Movements of vehicles in such car park areas and parking bays may be more erratic than on a road. For instance, when empty parking spaces are scarce or there are lots of pedestrians moving about in a crowded car park, a vehicle may, for example, in an effort to move into or otherwise secure an empty parking bay, undertake one or more sudden manoeuvers such as abrupt stops, reversing operations, U-turns or swerving motions. Also, owing to the proximal location of the drive-through facility with the car park, vehicles entering the drive-through facility may exhibit unpredictable movements similar to those executed in the car park. Conventional computer vision-based tracking systems may encounter significant difficulties in these environments, especially, when a view of a vehicle may be, partially or completely, occluded by obstacles, for example, other cars, vans, trolleys, people and other types of intervening objects.

Current tracking algorithms, which are designed for real-time use, tend to acccount for, short periods of time during which a change in a subject’s motion is most likely to be linear. In such cases, current tracking algorithms may work correctly only when used for such short periods of time thereby posing challenges when real-time tracking of the subject is required for a prolonged duration of time and, especially, when the subject’s motion is non-linear over time.

Most current re-identification algorithms are designed and intended for use in an offline setting and are incapable of real-time use. For example, current re-identification algorithms may be limited to their use in searching for a particular person or vehicle to see if they/it appears in frames of videos that have been recorded using one or more cameras setup at different positions in the environment.

In view of the above-mentioned technical differences between re-identification algorithms and tracking algorithms, current tracking system design and operational processes does not contemplate and, on the contrary, teach away from combining re-identification with tracking. Specifically, current literature on accomplishing system design for real-time tracking relates to the individual domains of re-identification and tracking separately. This entails specifying constrained conditions for each domain’s implementation and does not fully account for practical implementation in use-case scenarios of real-world applications such as those discussed in conjunction with the aforementioned environments, for example, a parking lot or parking bays. In particular, currently prevailing tracking systems lack any guidance relating to real-world scenarios in which a vehicle’s appearance may change significantly depending on, for example, illumination, viewing angle and other dynamically moving occlusions while the vehicle’s motion may also be changing non-linearly over time.

The SORT algorithm (as described in Bewley A, Ge Z., Ott L., Ramos F. and Upcroft B., Simple Online and Realtime Tracking 2016 IEEE International Conference on Image Processing (ICIP), Phoenix, AZ, 2016, pp. 3464-3468) and its successor the DeepSORT algorithm (as described in Wojke N., A. Bewley A. and Paulus D., “Simple online and realtime tracking with a deep association metric,” 2017 IEEE International Conference on Image Processing (ICIP), Beijing, 2017, pp. 3645-3649) are prior art tracking algorithms. Some of the more commonly known drawbacks associated with the use of the DeepSORT algorithm in the drive-through restaurant use case scenario, may include, but are not limited to:
inaccurate and/or incomplete detection of the location of the vehicle, wherein in a captured image of the vehicle, a bounding box that should ideally surround the vehicle embraces only a portion of the vehicle or the size of the bounding box fails to scale correctly according to the size of the vehicle, whereby the bounding box which should increase in size to surround a larger vehicle, instead, shrinks in size;
incomplete fine-tuning of the parameters of the Kalman filter models; and
failure to account for non-linear movements of vehicles, for example, when vehicles may rock back and forth i.e., in a reciprocating motion while an engine is idling or in response to sudden braking motion in a car park/drive through facility.

Similarly in the identity switch problem, the SORT and DeepSORT algorithms fail to recognize that a vehicle that may disappear from view behind one or more occlusions and later reappear in view is, in fact, the same vehicle and not another vehicle.

In view of the foregoing limitations and drawbacks that are associated with the use of current tracking systems, there exists a need for a system and a method for tracking a subject over a prolonged period of time in an environment where the subject is likely to execute non-linear motion; and during which time the subject may, in many instances, be at least partially occluded.

### SUMMARY

In an aspect of the present disclosure, there is provided a method for tracking and identifying vehicles. The method includes detecting a vehicle in a current video frame of a video stream, at a current time instance, establishing a bounding box around the detected vehicle, calculating a measurement vector of the detected vehicle, the measurement vector including horizontal and vertical locations of the centre of the bounding box at the current time instance, calculating a plurality of predicted measurement vectors for corresponding plurality of vehicles previously detected at a plurality of time instances preceding the current time instance, each predicted measurement vector being calculated based on the current measurement vector and a previous state vector of corresponding previously detected vehicle, calculating a plurality of first cost values for corresponding plurality of previously detected vehicles, each first cost value being calculated based on a distance between the current measurement vector of the detected vehicle, and a predicted measurement vector of corresponding previously detected vehicle, and identifying and storing the detected vehicle as a previously detected first vehicle, when the first cost value of the previously detected first vehicle is less than a first cost threshold.

In another aspect of the present disclosure, there is provided a system for tracking and identifying vehicles. The system includes a memory, and a processor communicatively coupled to the memory. The processor is configured to detect a vehicle in a current video frame of a video stream, at a current time instance, establish a bounding box around the detected vehicle, calculate a measurement vector of the detected vehicle, the measurement vector including horizontal and vertical locations of the centre of the bounding box at the current time instance, calculate a plurality of predicted measurement vectors for corresponding plurality of vehicles previously detected at a plurality of time instances preceding the current time instance, each predicted measurement vector being calculated based on the current measurement vector and a previous state vector of corresponding previously detected vehicle, calculate a plurality of first cost values for corresponding plurality of previously detected vehicles, each first cost value being calculated based on a distance between the current measurement vector of the detected vehicle, and a predicted measurement vector of corresponding previously detected vehicle, and identify and store the detected vehicle as a previously detected first vehicle, when the first cost value of the previously detected first vehicle is less than a first cost threshold.

In yet another aspect of the present disclosure, there is provided a non-transitory computer readable medium configured to store instructions that when executed by a processor, cause the processor to execute a method to track and identify a vehicle. The method comprising detecting a vehicle in a current video frame of a video stream, at a current time instance, establishing a bounding box around the detected vehicle, calculating a measurement vector of the detected vehicle, the measurement vector including horizontal and vertical locations of the centre of the bounding box at the current time instance, calculating a plurality of predicted measurement vectors for corresponding plurality of vehicles previously detected at a plurality of time instances preceding the current time instance, each predicted measurement vector being calculated based on the current measurement vector and a previous state vector of corresponding previously detected vehicle, calculating a plurality of first cost values for corresponding plurality of previously detected vehicles, each first cost value being calculated based on a distance between the current measurement vector of the detected vehicle, and a predicted measurement vector of corresponding previously detected vehicle, and identifying and storing the detected vehicle as a previously detected first vehicle, when the first cost value of the previously detected first vehicle is less than a first cost threshold.

To overcome the above-mentioned limitations and drawbacks, the present disclosure provides a system and a method for tracking of a subject over a prolonged period of time in an enviroment where the subject is likely to be executing non-linear motion over time and wherein the subject may, in many instances, be at least partially occluded during such time. For simplicity, in this disclosure, ‘the system’ will hereinafter be referred to as ‘the tracking system’.

In an aspect, the present disclosure can be regarded as being combinative of the prior art DeepSORT tracking algorithm with the prior art Views Knowledge Distillation (VKD) (as described in Porrello A., Bergamini L. and Calderara S., Robust Re-identification by Multiple View Knowledge Distillation, Computer Vision, ECCV 2020, Springer International Publishing, European Conference on Computer Vision, Glasgow, August 2020) re-identification algorithm. Specifically, the present disclosure aims to achieve the previously never considered goal of combining VKD’s ability to perform re-identification with the ability of the DeepSORT algorithm to track vehicles through images, to provide a tracking system that is robust to sudden and erratic vehicle movements and one or more intermittent partial or complete occlusions to the view of the vehicle.

By combining re-identification with tracking, the present disclosure addresses the failure of prior art tracking systems to recognize the advantages of obtaining a vehicle detection and identification at every sampling time to support Kalman filter calculations by reducing the effect of uncertainties represented by a process covariance matrix. When implemented operatively in a use-case scenario, the present disclosure distinguishes between a first process of detecting, identifying and determining the location of a studied vehicle and a second process of acquiring physical appearance attributes of the studied vehicle. Physical appearance attributes include but are not limited to, colour and colour variation embracing hue, tint, tone and/or shade, texture and texture variation, lustre, blobs, edges, corners, localised curvature and variations therein; and relative distances between the same.

Similarly, the present disclosure may replace the Faster Region CNN (FrCNN), of the DeepSort algorithm, with the YOLO v4 network architecture. The YOLO v4 network architecture provides more robust vehicle detection, recognition and bounding box parameters; and the VKD network architecture provides a more meaningful representation of the physical appearance attributes of a studied vehicle. This combination of network architectures also allows the system of the present disclosure to overcome the identity switch problem.

The measurement variables of the studied environment may comprise non-linear elements as a result of vehicles executing non-linear movements. To address this issue, the system of the present disclosure may optionally substitute a standard Kalman filter, pursuant to the implementation of the DeepSort algorithm, with an unscented Kalman filter. The selective substitution of the standard Kalman filter with the unscented Kalman filter also beneficially imparts flexibility to the system of the present disclosure for fusing data from different types of sensors, for example, video cameras and Radio Detection And Ranging (RADAR) sensors, such that the combined different types of sensor data can be used to optimally monitor the studied environment.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

FIG. 1A illustrates a tracking system showing various components therein, in accordance with an embodiment of the present disclosure;

FIG. 1B illustrates a processor of the tracking system in detail, in accordance with an embodiment of the present disclosure;

FIG. 2 illustrates an exemplary drive-through facility in which the tracking system of FIG. 1 may be implemented, in accordance with an embodiment of the present disclosure;

FIGS. 3A-3D illustrate a flowchart of a low-level implementation of a computer-implemented method for tracking subject(s) in a dynamic environment, for example, vehicle(s) in a drive-through facility, in accordance with an embodiment of the present disclosure; and

FIG. 4 is a flowchart illustrating a method for identifying and tracking vehicles, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

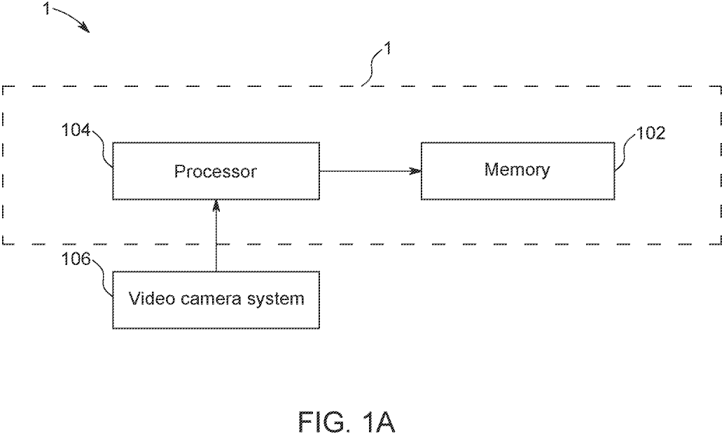

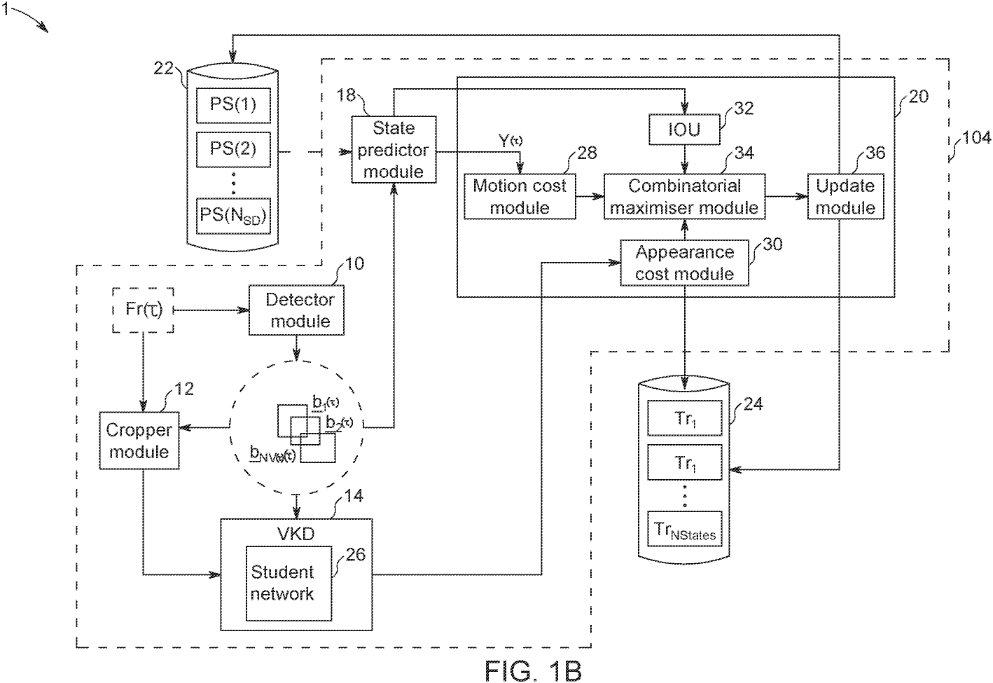

FIG. 1A illustrates a system 1 for tracking and identifying vehicles in an environment, for example, a drive through facility. The system 1 includes a memory 102, and a processor 104 communicatively coupled to the memory 102. The processor 104 is communicatively coupled to an external video camera system 106.

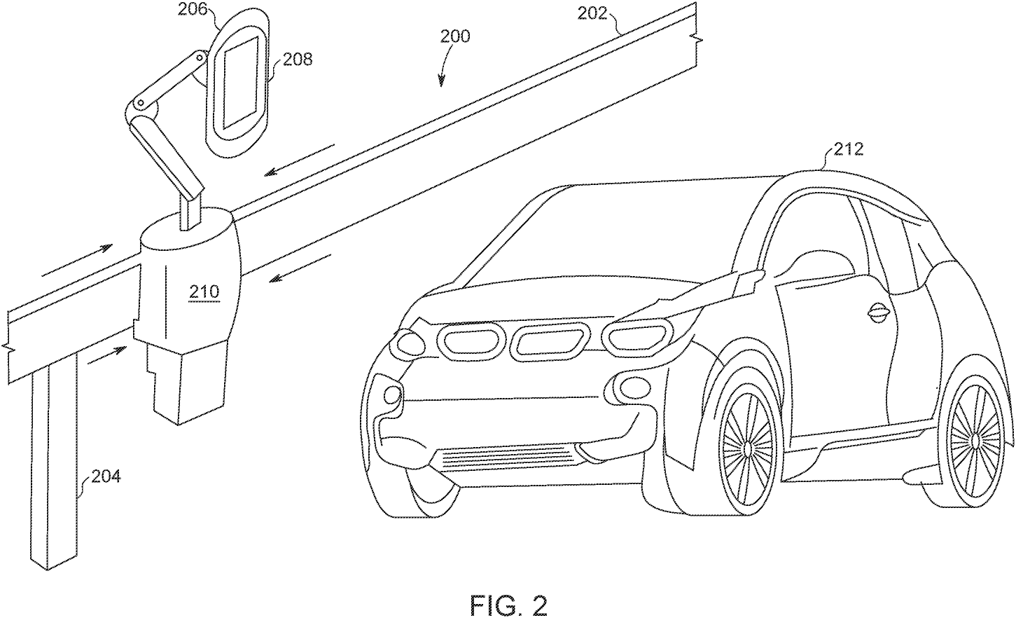

The video camera system 106 includes video cameras (not shown) are configured to capture video footage of an environment proximal to the one or more first locations and within the Field of View of the camera(s). In the case of the drive-through facility 200 (shown in FIG. 2), the video footage is captured by one or more video cameras (not shown) mounted in the drive-through facility 200.

The processor 104 may be a computer based system, that includes components that may be in a server or another computer system. The processor 104 may execute, by way of a processor (e.g., a single or multiple processors) or other hardware described herein. These methods, functions and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The processor 104 may execute software instructions or code stored on a non-transitory computer-readable storage medium to perform method and functions that are consistent with that of the present disclosure. In an example, the processor 104 may be embodied as a Central Processing Unit (CPU) having one or more Graphics Processing Units (GPUs) executing these software codes.

The instructions on the computer-readable storage medium are stored in the memory 102 which may be a random access memory (RAM). The memory 102 provides a large space for keeping static data where at least some instructions could be stored for later execution. The stored instructions may be further compiled to generate other representations of the instructions and dynamically stored in the memory 102. The processor 104 reads instructions from the memory 102 and performs actions as instructed.

The processor 104 may be externally communicatively coupled to an output device to provide at least some of the results of the execution as output including, but not limited to, visual information to a user. The output device may include a display on general purpose, or specific-types of, computing devices including, but not limited to, laptops, mobile phones, personal digital assistants (PDAs), Personal Computers (PCs), virtual reality glasses and the like. By way of an example, the display of the output device can be integrally formed with, and reside on, a mobile phone or a laptop. The graphical user interface (GUI) and text, images, and/or video contained therein may be presented as an output on the display of the output device. The processor 104 may be communicatively coupled to an input device to provide a user or another device with mechanisms for providing data and/or otherwise interacting therewith. The input device may include, for example, a keyboard, a keypad, a mouse, or a touchscreen. Each of these output and input devices could be joined, for purposes of communication, by one or more additional wired, or wireless, peripherals and/or communication linkages.

FIG. 1B illustrates the software components of the processor 104 in detail. The processor 104 includes a Detector Module 10, a Cropper Module 12, an Appearance Variables Extractor Module 14, a State Predictor Module 18, a Matcher Module 20, and the memory 102 may include a Previous State Database 22 and a Tracking Database 24.

The Detector Module 10 is communicatively coupled with one or more video cameras (not shown) of the video camera system 106 installed at one or more first locations proximal to the premises under observation (e.g. the drive-through facility). The video cameras (not shown) are configured to capture video footage of an environment within a predefined distance of the one or more first locations and within the Field of View of the camera(s).

The video footage from a video camera (not shown) includes a plurality of successively captured video frames Fr, wherein n is the number of video frames in the captured video footage. Let a time τ be the time at which a first video frame of a given item of video footage is captured by a video camera. The time interval Δt between the captures of successive video frames of the video footage will be referred to henceforth as the sampling interval. Using this notation, the video footage can be described as VID ∈ ℝ^{nx(pxm)} = [Fr(τ), Fr(τ + Δt), Fr(τ + 2Δt) .... Fr(τ + nΔt)]. Fr(τ + iΔt) ∈ ℝ^{pxm} denotes an individual video frame of the video footage, the said video frame being captured at a time τ + iΔt, which is henceforth known as the sampling time of the video frame.

For clarity, in the following discussions, a current sampling time t_{c} is given by t_{c} = τ + NΔt, where N < n. A previous sampling time tₚ is a sampling time that precedes the current sampling time t_{c} and is given by tₚ = τ + DΔt where 0 < D < N. A current video frame Fr(t_{c}) is a video frame captured at a current sampling time t_{c}. A previous video frame Fr(tₚ) is a video frame captured at a previous sampling time tₚ. Similarly, a currently detected vehicle is a vehicle that is detected in a current video frame Fr(t_{c}). A previously detected vehicle is a vehicle that has been detected in a previous video frame Fr(tₚ). A previous detection of a vehicle is the detection of the vehicle in a previous video frame Fr(tₚ). A current detection of a vehicle is the detection of the vehicle in the current video frame Fr(t_{c}). Further, a most recent previous detection of a vehicle is a one of a one or more previous detections of a given vehicle at a previous sampling time that is closest to the current sampling time, or in other words, at a given current time t_{c}, a most recent previous detection of a vehicle is the last previous detection of the vehicle in the previous video frames.

Individual video frames captured by q>1 video cameras at a given sampling time (τ+iΔt) can be concatenated, so that the video footage captured by the collective body of video cameras can be described as:

$$\begin{matrix}V I D ∈ {ℝ}^{\left(p x m\right) x \left(n x q\right)} = \left[{\left[F {r}_{0} \left(τ\right) , F {r}_{1} \left(τ\right) … … . F {r}_{q} \left(τ\right)\right]}^{T} , \left[F {r}_{0} \left(τ + Δ t\right) , F {r}_{1} \left(τ +\right)\right)\right) \\ \left(Δ \left(t\right) … … . F {r}_{q} \left(τ + Δ t\right)\right] \left({}^{T} , … , {\left[F {r}_{0} \left(τ + n Δ t\right) , F {r}_{1} \left(τ + n Δ t\right) … … . F {r}_{q} \left(\left(τ + n Δ t\right)\right]\right)}^{T}\right]\end{matrix}$$

For brevity, a video frame formed by concatenating a plurality of video frames each of which was captured at the same sampling time (for example, [Fr₀(τ), Fr₁(τ) ....... Fr_{q}(τ)]^{T}) will be referred to henceforth as a “Concatenated Video Frame”. Similarly, individual video frames concatenated within a Concatenated Video Frame will be referred to henceforth as “Concatenate Members”.

The Detector Module 10 includes an object detector algorithm configured to receive a video frame or a Concatenated Video Frame and to detect therein the presence of a vehicle. In the present embodiment and use case of a drive-through facility, the object detector algorithm is further configured to classify the detected vehicle as being one of, for example, a sedan, a sport utility vehicle (SUV), a truck, a cabrio, a minivan, a minibus, a microbus, a motorcycle and a bicycle. The classifying being denoted by applying a corresponding classification label to the video frame or Concatenated Video Frame. The skilled person will understand that the above-mentioned vehicle classes are provided for example purposes only. In particular, the skilled person will understand that the tracking system 1 of the present disclosure is not limited to the detection of vehicles of the above-mentioned classes, or for that matter, detection of vehicles alone. Instead, and for purposes of the present disclosure, the tracking system 1 may only be regarded as being capable, or adaptable, to detect any class of movable vehicle that is detectable in a video frame.

The object detector algorithm is further configured to determine the location of the detected vehicle in the video frame or Concatenated Video Frame. As disclosed earlier herein, the location of a detected vehicle is represented by the co-ordinates of a bounding box which is configured to enclose the vehicle. The co-ordinates of a bounding box are established with respect to the coordinate system of the video frame or Concatenated Video Frame. In particular, the object detector algorithm is configured to receive individual successively captured video frames Fr(τ + iΔt) from the video footage VID; and to process each video frame Fr(τ + iΔt) to produce one or more variables of a plurality of bounding boxes B(τ + iΔt) = [b₁(τ + iΔt), b₂(τ + iΔt) ... . . b_{nb} (τ + iΔt))]^{T}, nb ≤ N_{Veh}(τ + iΔt) , where N_{Veh}(τ + iΔt) is the number of vehicles detected and identified in the video frame Fr(τ + iΔt) and b_{nb} (τ + iΔt) is the bounding box encompassing an nb^{th} vehicle. The variables of each bounding box b_{nb} (τ + iΔt) comprise four co-ordinates, namely [x,y], h and w, where [x,y] is the co-ordinates of the upper left corner of the bounding box relative to the upper left corner of the video frame (whose coordinates are [0,0]); and h,w are the height and width of the bounding box respectively. For brevity, the co-ordinates of a bounding box enclosing a vehicle detected in a received video frame will be referred to henceforth as a Detection Measurement Vector. Thus, the output from the Detector Module 10 includes one or more Detection Measurement Vectors, each of which includes the co-ordinates of a bounding box enclosing a vehicle detected in a received video frame.

To this end, the object detector algorithm includes a deep neural network whose architecture is substantially based on the EfficientDet (as described in M. Tan, R. Pang and Q.V. Le, EfficientDet: Scalable and Efficient Object Detection, 2020 IEEE/CVF Conference on Computer Vision and Pattern Recognition (CVPR), Seattle, WA, USA, 2020, pp. 10778-10787). Scaling up the feature network and the box/class prediction network in the EfficientDet are critical to achieving both accuracy and efficiency. Similarly, the loss function of the EfficientDet network is based on a Focal Loss which focuses training on a sparse set of hard examples. The architecture of the deep neural network of the object detector algorithm may also be based on You look only once (YOLO) v4 (as described in A Bochkovskiy, C-Y Wang and H-Y M Liao, 2020 arXiv: 2004.10934). However, the skilled person will understand that these deep neural network architectures are provided for example purposes only. In particular, the skilled person will understand that the tracking system 1 of the present disclosure is not limited to these deep neural network architectures. On the contrary, the tracking system 1 is operable with any deep neural network architecture and/or training algorithm, such as region based convolutional neural networks (R-CNN), Fast R-CNN, Faster R-CNN and spatial pyramidal pooling networks (SPP-net) which is suitable for the detection, classification and localization of a vehicle in an image or video frame or concatenation of the same.

The goal of training the object detector algorithm is to cause it to establish an internal representation of a vehicle, wherein the internal representation allows the Detector Module 10 to recognize a vehicle in subsequently received video footage. To meet this aim, the dataset used to train the object detector algorithm consists of video footage of a variety of scenarios recorded in a variety of different drive-through facilities and/or establishments i.e., historical video frames from other similar locations. For example, the dataset could include video footage of a scenario in which vehicle(s) are entering a drive-through facility; vehicle(s) are progressing through the drive-through facility; vehicle(s) are leaving the drive-through facility; a vehicle is parking in a location proximal to the drive-through facility; or vehicle is re-entering the drive-through facility.

The video footage, which will henceforth be referred to as the Training Dataset is assembled with the aim of providing robust, class-balanced information to the Detector Module 10 about subject vehicles derived from different views of a vehicle obtained from different viewing angles, which are representative of the intended usage environment of the tracking system 1 and therefore can be regarded as that which may be similarly encountered by the tracking system 1 in actual, or real-time, operation.

The members of the Training Dataset are selected to create sufficient diversity to overcome the challenges to subsequent vehicle recognition posed by variations in illumination conditions, perspective changes or a cluttered background, while also accounting for intra-class variation. In most instances, images of a given scenario are acquired from multiple cameras, thereby providing multiple viewpoints of the scenario. Each of the multiple cameras may be set up, during installation, in a variety of different locations to record the different scenarios in the Training Dataset to allow the Detector Module 10 to operatively overcome challenges to recognition posed by view-point variation.

Prior to its use in the Training Dataset, the video footage is processed to remove video frames/images that are very similar. Similarly, some members of the Training Dataset may also be used to train the Appearance Variables Extractor Module 14 as will be explained later herein. The members of the Training Dataset may also be subjected to further data augmentation techniques to increase the diversity thereof and thereby increase the robustness of the trained Detector Module 10. Specifically, the images/video frames are resized to a standard size wherein the size is selected to balance the advantages of more precise details in the video frame/image against the cost of more computationally expensive network architectures required to process the video frame/image. Similarly, all of the images/video frames are re-scaled to a value in the interval [-1, 1], so that no features of an image/video frame have significantly larger values than the other features.

In a further pre-processing step, individual images/video frames in the video footage of the Training Dataset are provided with one more bounding boxes, wherein each such bounding box is arranged to enclose a vehicle visible in the image/video frame. The extent of occlusion of the view of a vehicle in an image/video frame is assessed. Those vehicles whose view in an image/video frame is, for example, more than 70% un-occluded are labelled with the class of the vehicle (wherein the classification label is selected from the set comprising, for example, sedan, cabrio, SUV, truck, minivan, minibus, bus, bicycle, or a motorcycle). Accordingly, individual images/video frames in the Training Dataset are further provided with a unique identifier, namely the class label, which is used, as will be described later, for the training of the Appearance Variables Extractor Module 14.

Using the above training process, once suitably trained the Detector Module 10 is used for subsequent real-time processing of video footage. In the case of the drive-through facility 200 (shown in FIG. 2), the video footage is captured by one or more video cameras (not shown) mounted in the drive-through facility 200. In particular, the Detector Module 10 is configured to receive a current video frame Fr(t_{c}) from the video footage VID and to calculate therefrom one or more Detection Measurement Vector(s), each of which includes the co-ordinates of a bounding box enclosing a vehicle detected in the current video frame Fr(t_{c}). The Detector Module 10 is communicatively coupled with the Cropper Module 12 and the State Predictor Module 18 to transmit thereto the Detection Measurement Vector(s).

The Cropper Module 12 is configured to receive the current video frame Fr(t_{c}) and to receive one or more Detection Measurement Vectors from the Detector Module 10. The Cropper Module 12 is further configured to crop the current video frame Fr(t_{c}) to the region(s) enclosed by the bounding box(es) specified in the Detection Measurement Vectors. For brevity, a cropped region that is enclosed by a bounding box, will be referred to henceforth as a Cropped Region. The Cropper Module 12 is further configured to transmit the Cropped Region(s) to the Appearance Variables Extractor Module 14. While the Cropper Module 12 is described herein as being a separate component to the Detector Module 10, the skilled person will understand that the Cropper Module 12 and the Detector Module 10 could also be combined into a single functional component.

The Detector Module 10 is communicatively coupled with the State Predictor Module 18 and the Cropper Module 12 to transmit thereto the Detection Measurement vector(s) calculated from the received video frame (Fr(τ)). In an example, the State Predictor Module 18 may include a Kalman filter module, and is hereinafter also referred to as State Predictor Module 18.

The State Predictor Module 18 is configured to receive a Detection Measurement Vector from the Detector Module 10, wherein the Detection Measurement Vector includes the co-ordinates of a bounding box enclosing a vehicle detected in a current video frame Fr(t_{c}). The State Predictor Module 18 is further configured to extract from the received Detection Measurement Vector an Actual Measurement Vector zₙₐₘᵥ (t_{c}) = [u, v, s, r] where u and v respectively represent the horizontal and vertical location of the centre of the bounding box in the Detection Measurement Vector; and s and r respectively represent the scale and aspect ratio of the bounding box in the Detection Measurement Vector. The measurement vector generated at the current time instance t_{c}, is hereinafter also referred to as actual measurement vector or current measurement vector.

The State Predictor Module 18 is further communicatively coupled with the Previous State Database 22. The Previous State Database 22 stores a plurality of previous state vectors for a plurality of previously detected vehicles, each previous state vector being calculated based on most recent observation of corresponding previously detected vehicle at a time instance preceding the current time instance. In an example, if hundred vehicles have been detected in the past, then the previous state database 22 would include 100 previous state vectors corresponding to most recent observations of those 100 vehicles.

The Previous State Database 22 includes a plurality of Previous State vectors psⱼ, j ≤ N_{PSV}. Given a current sampling time t_{c} and historical video footage VID = [Fr(tₚ)]_{D=0} _{to N-1} captured from a first sampling time τ until the current sampling time t_{c}, a Previous State Vector is derived from a most recent previous detection of a previously detected vehicle. Specifically, a Previous State Vector psⱼ of a j^{th} vehicle is denoted by psⱼ = [ϕ; u,v,s,r,u′,v′,s′,r′]^{T} where:
ϕ is the sampling time at which the j^{th} previously detected vehicle was last observed -it should be noted that ϕ and the current sampling time may differ by more than one sampling interval, because a vehicle may have been occluded in the video frame(s) captured at the sampling time immediately preceding the current sampling time (i.e. at sampling time t_{c} - Δt)
j ≤ N_{PSV} where N_{PSV} is the total number of Previous State Vectors in the Previous State Database 22 (representing the total number of different vehicles previously observed over a pre-defined time interval iΔt);
u and v respectively represent the horizontal and vertical location of the centre of the bounding box bⱼ(ϕ) surrounding the j^{th} vehicle detected at sampling time ϕ;
s and r respectively represent the scale and aspect ratio of the bounding box bⱼ (ϕ);
u′ and v′ respectively represent the first derivative of the horizontal and vertical location of the centre of the bounding box bⱼ (ϕ); and
s′ and r′ respectively represent the first derivative of the scale and aspect ratio of the bounding box bⱼ(ϕ).

The Previous State Database 22 is initially populated with Previous State Vectors derived from the first video frame Fr(τ) of the historical video footage, wherein N_{Veh}(τ) is the total number of vehicles observed in the first video frame Fr(τ) and the first derivative terms (u′, v′, s′ and r′) of each of these Previous State Vectors is initialised to a value of zero.

In operation, for a vehicle detected in a current video frame, the State Predictor Module 18 is configured to receive a corresponding Detection Measurement vector from the Detector Module 10, and to retrieve the Previous State vectors from the Previous State Database 22. The State Predictor Module 18 is further configured to estimate candidate dynamics of the detected vehicle enclosed by the bounding box whose details are contained in the Detection Measurement vector based on the estimated dynamics of previously detected vehicles (represented by the Previous State vectors retrieved from the Previous State Database 22). For brevity, the estimated dynamics of a currently detected vehicle based on the Previous State vector (of a previously detected vehicle), will be referred to henceforth as the Predicted State vector of the currently detected vehicle.

Thus, using this nomenclature, for a given detected vehicle in a current video frame obtained at the current time instance, the State Predictor Module 18 is configured to calculate one or more candidate Predicted State vectors corresponding to one or more previously detected vehicles.

The State Predictor Module 18 is further configured to retrieve from the Previous State Database 22 each Previous State vector psⱼ(ϕ), j ≤ N_{PSV}. The State Predictor Module 18 is further configured to use a Kalman filter algorithm to process an Actual Measurement Vector zₙₐₘᵥ (t_{c}) and each Previous State Vector psⱼ(ϕ) to thereby calculate a plurality of Predicted State Vectors. Thus, the State Predictor Module 18 calculates a plurality of predicted measurement vectors for corresponding plurality of previously detected vehicles. The skilled person will understand that the State Predictor Module 18 of the present disclosure is not limited to the use of the Kalman filter algorithm. On the contrary, the tracking system of the present disclosure is operable with any algorithm capable of state estimation for a stochastic discrete-time system, such as a moving horizon estimation algorithm or a particle filtering algorithm. However, for the purpose of illustration, the present disclosure will discuss the operations of the State Predictor Module 18 with reference to a Kalman filter.

For simplicity, rather than discussing state prediction for every vehicle detected in a current video frame Fr(t_{c}), the following description will focus on establishing an individual Predicted State Vector of an individual vehicle detected in the current video frame Fr(t_{c}). However, it will be understood that should a plurality of vehicles be detected in a current video frame Fr(t_{c}), the process of state prediction as described below will be effectively repeated for each such detected vehicle. Thus, for ease of understanding, the “j” subscript is omitted from the following expressions relating to the operations of the Kalman filter.

Similarly, since ϕ may not differ from t_{c} by one sampling interval, the following discussion will, for simplicity, use a generic timing index γ to represent consecutive Actual Measurement Vector and Previous State Vector samples. In other words, any difference between ϕ and t_{c}, beyond one sampling interval, will be disregarded in the following discussion of the Kalman filter calculations in the State Predictor Module 18, as will the value of ϕ. Thus, using the above simplifications, an Actual Measurement Vector zₙₐₘᵥ (t_{c}) at a current sample γ is denoted by z(γ); and a given Previous State Vector is denoted by x(γ - 1).

Thus, the Kalman filter assumes that a Detection State Vector (x̂(γ)_{|γ-1}) at sampling time γ is evolved from the Previous State Vector (x̂(γ - 1)_{|γ-1)} at sampling time γ-1 according to

$$\hat{\underline{x}} {\left(γ\right)}_{\left|γ - 1\right)} = {F}_{γ} \hat{\underline{x}} {\left(γ - 1\right)}_{\left|γ - 1\right)} + {B}_{γ} \underline{u} \left(γ\right) + \underline{w} \left(γ\right)$$

where:
F_{γ} is the state transition matrix applied to the Previous State Vector x(γ — 1), and is formulated in the tracking system 1 of the present disclosure, under the assumption that an observed vehicle is moving at constant velocity;
u(γ) is a control vector, used to estimate how external forces may be influencing the observed vehicle; but owing to the complexity of assessing this, the elements of u(γ) in the tracking system 1 of the present disclosure are set to a value of zero (in other words u(γ) is a zero vector);
w(γ) is the process noise which is assumed to be drawn from a zero mean multivariate normal distribution with process covariance Q(y)(i.e., w(γ)~N(0, Q(y)); and
Q(y) is the process covariance matrix which represents the uncertainty about the true velocity of the vehicle. While the state transition matrix F_{γ} is formulated with the assumption of constant velocity, the vehicle may in fact be accelerating. The process covariance matrix Q(y) depends on the sampling interval and the variability in the random acceleration of the vehicle. If the random acceleration is more variable, the process covariance matrix Q(y) has a larger magnitude. Hence the importance of obtaining a vehicle detection and identification at every sampling time from the Detector Module 10, to generate an Actual Measurement Vector z(y) for a vehicle at each sampling time, thereby reducing the effect of the process covariance matrix Q(y) on the evolution of the Detection State Vector (x̂(γ)_{|γ-1}) .

Q(y) disclosed herein is initialised using the following method. Assuming the confidence in the measurement variables of an Actual Measurement Vector z(y) follows a Gaussian distribution, a first variable relating to the standard deviation of the measurements of the location of the vehicle is set to a pre-defined value. In one exemplary embodiment, the pre-defined value may be set to 0.05. A second variable relating to the standard deviation of the measurements of the vehicle’s velocity is also set to a pre-defined value. In one exemplary embodiment, the pre-defined value may be set 1/160. However, the skilled person will understand that the present disclosure is not limited to these pre-defined value for the first and second variables. On the contrary, the present disclosure is operable with any pre-defined value of the first and second variables as may be empirically, or otherwise, established for a given configuration of the tracking system 1 and environment in which it is used. Specifically, the preferred embodiment is operable with any pre-defined values of the first and second variables suitable to enable initialisation of the process covariance matrix according to the setup of the observed environment and the tracking system therein .

An intermediary vector is constructed from the first and second variables multiplied by the Actual Measurement vector z(y) and a constant of a further predefined value which may be empirically, or otherwise, established for a given configuration of the tracking system 1 and environment in which it is used. A diagonal covariance matrix is constructed using the intermediary vector. In particular, the diagonal covariance matrix is constructed so that each element on the diagonal is the corresponding element from the intermediary vector raised to the power of 2.

In one embodiment, and mirroring the above state evolution, the Kalman filter algorithm implements a vehicle covariance matrix evolution as follows:

$$P {\left(γ\right)}_{\left|γ - 1\right)} = {F}_{γ} P {\left(γ - 1\right)}_{\left|γ - 1\right)} {F}_{γ} {}^{T} + Q \left(γ\right)$$

where P(γ)_{|γ-1} is the estimated prediction of the vehicle covariance matrix which represents the uncertainty in the vehicle’s state.

Thus, to implement the Kalman filter algorithm it is necessary to determine the state transition matrix F_{γ} and the process covariance matrix Q(y). To this end, the State Predictor Module 18 operates in alternating prediction and update phases. The prediction phase employs expressions (2) and (3) above. In the update phase, a Detection State Vector (x̂(γ)_{|γ-1}) is combined with the Actual Measurement Vector z(y) to refine the estimate of a Predicted State Vector (x̂(γ)_{|γ}) as sequentially given by way of computational equations 4-9 below.

$$\hat{\underline{y}} \left(γ\right) = \underline{z} \left(γ\right) - {H}_{γ} \hat{\underline{x}} {\left(γ\right)}_{\left|γ - 1\right)}$$

$${S}_{γ} = {H}_{γ} P {\left(γ\right)}_{\left|γ - 1\right)} {H}_{γ} {}^{T} + {R}_{γ}$$

$${K}_{γ} = P {\left(γ\right)}_{\left|γ - 1\right)} {H}_{γ} {}^{T} {S}_{γ} {}^{- 1}$$

$$\hat{\underline{x}} {\left(γ\right)}_{\left|γ\right)} = \hat{\underline{x}} {\left(γ\right)}_{\left|γ - 1\right)} + {K}_{γ} \hat{\underline{y}} \left(γ\right)$$

$$P {\left(γ\right)}_{\left|γ\right)} = \left(I - {K}_{γ} {H}_{γ}\right) P {\left(γ\right)}_{\left|γ - 1\right)}$$

$$\hat{\underline{y}} {\left(γ\right)}_{\left|γ\right)} = \underline{z} \left(γ\right) - {H}_{γ} \hat{\underline{x}} {\left(γ\right)}_{\left|γ\right)}$$

Where
H_{γ} is a pre-defined measurement matrix which translates a Detection State Vector or a Predicted State Vector (x̂(γ)_{|γ-1} or x̂(γ)_{|γ}) into the same space as the Actual Measurement Vector z(y);
R_{γ} is the measurement noise;
K_{γ} is the Kalman gain, which is used to estimate the importance of error on the Detection State Vector;
P(γ)_{|γ-1} is the predicted vehicle covariance; and
P(γ)_{|γ} is the updated belief as to the vehicle covariance matrix.

Assuming the confidence in the measurement variables of an Actual Measurement vector z(y) follow a Gaussian distribution, the measurement noise R_{γ} is established as follows. A first variable related to the standard deviation of the measurements of the location of the vehicle is set to a pre-defined value. In one exemplary embodiment, the pre-defined value may be set to 0.05. The first variable is multiplied by the mean of the distribution of each of the vehicle location variables with respect to the Actual Measurement vector z(γ). The measurement noise R_{γ} is a diagonal matrix established based on the resulting values of the above multiplication, wherein each of the resulting values is raised to the power of two.

Specifically, the update process includes:
measuring a post-fit residual ŷ(y) between the Actual Measurement Vector z(y) and a Predicted Measurement Vector (m̂(γ)) calculated from the Predicted State Vector (i.e. m(y) = H_{γ}x̂(γ)_{|γ});
calculating a Kalman gain which represents how much a measurement affects the modelled system dynamics. The smaller the magnitude of the Kalman gain, the less the model is affected by a new measurement that is different from the prediction. The Kalman gain depends on the covariances of the prediction and the measurement, wherein the more uncertainty in the prediction the more a new measurement can change the prediction. Similarly, the greater the uncertainty in the prediction, the less a new measurement can change the prediction. Using these steps, a Predicted Measurement Vector (m̂(γ)) is brought closer to the Actual Measurement Vector z(y), where the amount of influence the measurement has on the model depends on the uncertainty in the prediction and the uncertainty in the measurement; and
decreasing the vehicle covariance by an amount that depends on the certainty of the measurement.

In a further embodiment, to additionally, or optionally, address the potential for the Kalman filter equations being non-linear, for example, if the measurement variables of the Actual Measurement vector z(y) included RADAR measurements, an unscented Kalman filter approach may be used. In this approach, the state distribution is approximated by a Gaussian Random Variable (GRV), but is represented using a minimal set of sample points which completely capture the true mean and covariance of the Gaussian Random Variable when propagated through the true non-linear system.

Using the above alternating prediction and update phases, the post-fit residual ŷ(γ)_{|γ} is the output from the Kalman Filter algorithm for the purpose of the tracking system 1 of the present disclosure. As previously mentioned, the above derivation relates to the predicted motion of a single vehicle. The above derivation is expanded to embrace post-fit residuals for every vehicle detected in a current video frame Fr(t_{c}). Similarly, for sake of consistency in the rest of the present disclosure, the specific sampling time nomenclature consistent with that of the foregoing disclosure is used.

Thus, the resulting output from the State Predictor Module 18 is the Post-fit Residual Matrix Y(t_{c)}^{T} ∈ ℝ^{N_{Veh}(τ)}, wherein each Post-fit Residual ŷⱼ(t_{c}) is calculated as the difference between each Predicted Measurement Vector (m̂ⱼ(t_{c})) and each Actual Measurement Vector zₙₐₘᵥ (t_{c}) .

The State Predictor Module 18 is communicatively coupled with the Matcher Module 20 to transmit thereto the candidate Predicted State vector(s) and the Actual Measurement vector of the currently detected vehicle. The Matcher Module 20 is configured to calculate a Candidate Measurement vector from the candidate Predicted State vector. The Matcher Module 20 is further configured to calculate a distance between the Actual Measurement vector for a detected vehicle and the Candidate Measurement vector. The Matcher Module 20 is configured to receive a plurality of Detected Appearance Vectors A(t_{c}) and a plurality of Predicted State Vectors (i.e. x̂ⱼ(t_{c})_{|tc} (or a plurality of Predicted Measurement Vectors (m̂(t_{c}))) from the Appearance Variables Extractor Module 14 and the State Predictor Module 18 respectively. By comparing the distance values calculated from different previously detected vehicles, it is possible to determine which (if any) of the previously detected vehicles most closely matches the current detected vehicle. In other words, this process enables re-identification of detected vehicles.

The Appearance Variables Extractor Module 14 employs a VKD Network comprising a teacher network (not shown) communicatively coupled with a student network 26. The teacher network (not shown) and the student network 26 have substantially matching architectures, for example, a ResNet-101 convolutional neural network (as described in He K., Zhang X., Ren S. and Sun J. “Deep Residual Learning for Image Recognition”, IEEE Conference on Computer Vision and Pattern Recognition (CVPR), Las Vegas, NV, 2016, pp. 770-778) with a bottleneck attention module (as described in Park, J., Woo, S., Lee, J., Kweon, I.S.: “BAM: bottleneck attention module” in British Machine Vision Conference (BMVC) 2018). The skilled person will understand that the above network architectures are provided for example only. In particular, the skilled person will understand that the tracking system 1 is in no way limited to the above-mentioned network architectures. Instead, the tracking system 1 is operable with any network architecture capable of forming an internal representation of a vehicle based on one or more of its physical appearance attributes, for example, a ResNet-34, ResNet-50, DenseNet-121 or a MobileNet.

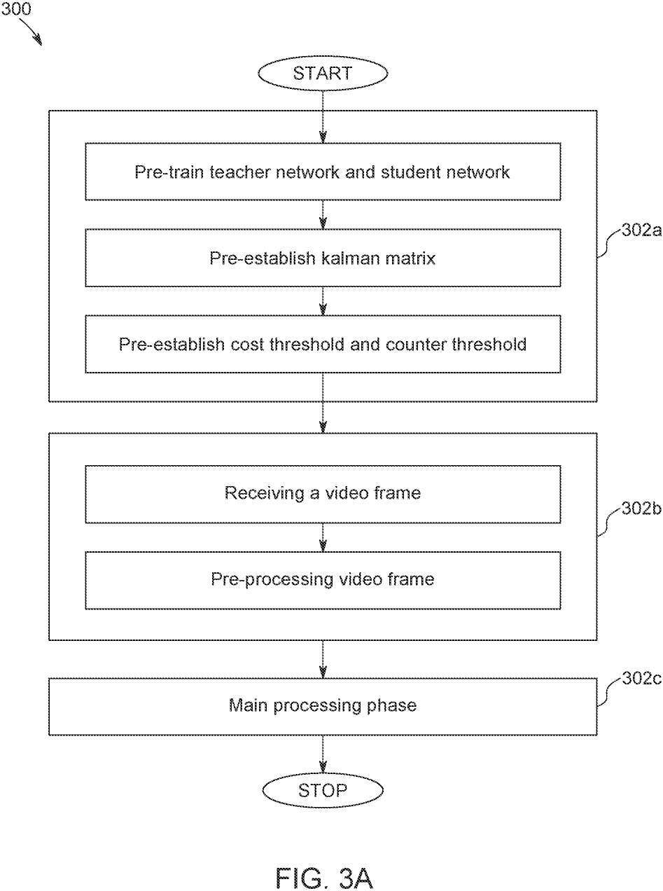

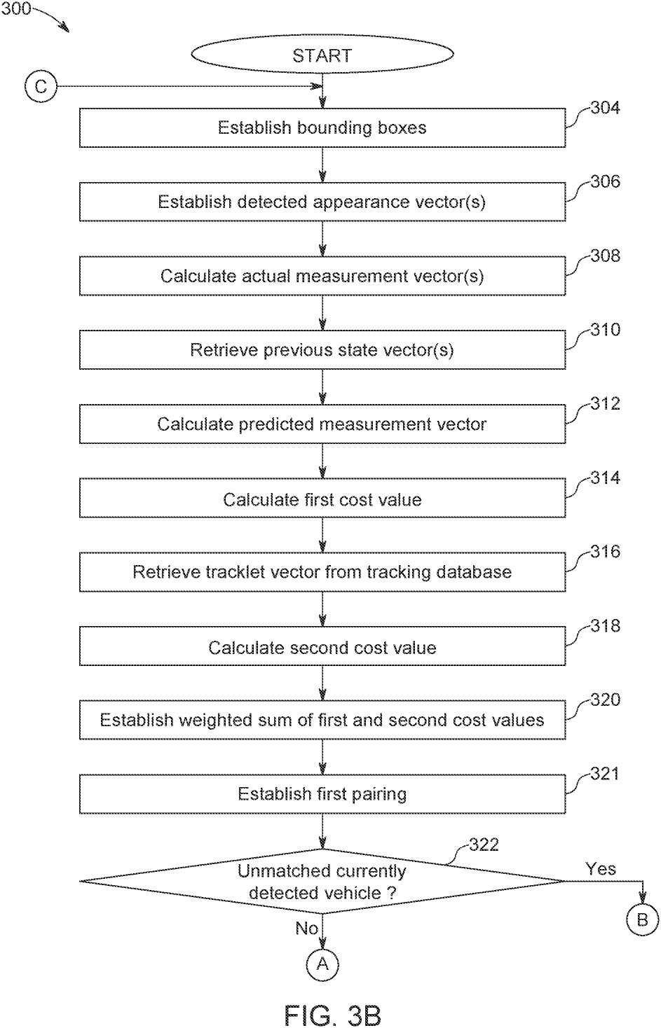

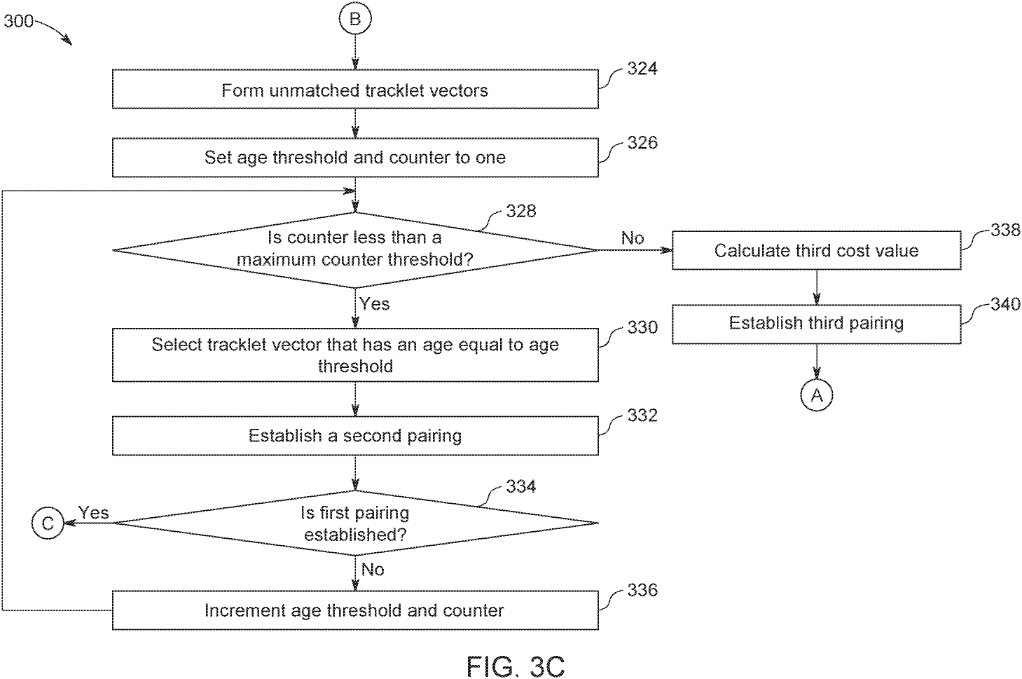

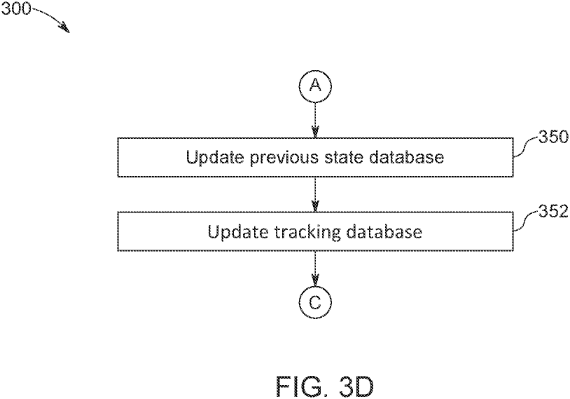

Prior to operation of the tracking system 1 (during a setup phase 302a of the method for tracking of subject(s) shown in FIG. 3a and discussed in more detail below), the teacher network (not shown) is trained on a selected plurality of video frames, and the student network 26 is trained from the teacher network (not shown) in a self-distillation mode as described below. In this way, the teacher network (not shown) and the student network 26 are trained to establish an internal representation of the appearance of a vehicle to permit subsequent identification of the vehicle should it appear in further captured video frames.

The teacher network (not shown) and the student network 26 are respectively trained using a first subset and a second subset of a gallery comprising a plurality of Concatenated Video Frames. Thus, the gallery includes a plurality of scenes viewed from different viewpoints by a plurality of video cameras. In at least some of the scenes, one or more classes of vehicle are visible. For example, a scene could represent a car entering a drive through facility, a car progressing through the drive through facility, a car leaving the drive through facility, a car parking in a location proximal to the drive through facility, or a car re-entering the drive through facility. It should be noted that these scenes mirror those used to establish the Training Dataset for the object detector algorithm of Detector Module 10. Hence, at least some of the members of the Training Dataset may be used as members of the gallery. The skilled person will understand that the above-mentioned scenarios are provided only to illustrate potential scenes that may be included in the gallery. Accordingly, the skilled person will further also understand that use of the tracking system 1 of the present disclosure is in no way limited to the scenarions represented by the above-mentioned scenes. Instead, the tracking system 1 of the present disclosure is operable with a gallery comprising scenes of any vehicle regardless of a state of operation, or otherwise, in which such vehicle is present.

The first subset (Tr_SS₁) includes a first number (X₁) of Concatenated Video Frames from the gallery, as shown below:

$$\begin{matrix}T r \_ S {S}_{1} ∈ {ℝ}^{\left(p x m\right) x \left({Y}_{1} x {X}_{1}\right)} = \left[{\left[F {r}_{0} \left(τ\right) , F {r}_{1} \left(τ\right) … … . F {r}_{{X}_{1}} \left(τ\right)\right]}^{T} , \left[F {r}_{0} \left(τ + Δ t\right) , F {r}_{1} ( τ +\right)\right) \\ \left(Δ t ) … … . F {r}_{{X}_{1}} {\left(\left(τ + Δ t\right)\right]}^{T} , … , {\left[F {r}_{0} \left(τ + {Y}_{1} Δ t\right) , F {r}_{1} \left(τ + {Y}_{1} Δ t\right) … … . F {r}_{{X}_{1}} \left(τ + Y {}_{1} Δ t\right)\right]}^{T}\right]\end{matrix}$$

The second subset (Tr_SS₂) includes a second number (X₂) of Concatenated Video Frames from the gallery, wherein X₂<X₁, as shown below:

$$\begin{matrix}T r \_ S {S}_{2} ∈ {ℝ}^{\left(p x m\right) x \left({Y}_{2} x {X}_{2}\right)} = \left[{\left[F {r}_{0} \left(τ\right) , F {r}_{1} \left(τ\right) … … . F {r}_{{X}_{2}} \left(τ\right)\right]}^{T} , \left[F {r}_{0} \left(τ + Δ t\right) , F {r}_{1} \left(τ +\right)\right)\right) \\ \left(Δ t\right) … … . F {r}_{{X}_{2}} {\left(\left(τ + Δ t\right)\right]}^{T} , … , \left({\left[\left(F {r}_{0} \left(τ + {Y}_{2} Δ t\right) , F {r}_{1} \left(τ + {Y}_{2} Δ t\right) … … . F {r}_{{X}_{2}} \left(τ + {Y}_{1} Δ t\right)\right]\right)}^{T}\right]\end{matrix}$$

Thus, the first and second subsets include images of the same scenes, but differ according to the number of Concatenate Members in their respective Concatenated Video Frames. Specifically, the first subset includes Concatenated Video Frames with a larger number of Concatenate Members than the Concatenated Video Frames of the second subset. Thus, the first subset is designed to support Video to Video (V2V) matching in which the teacher network (not shown) matches a vehicle visible in several video frames (representing different views of that same vehicle) captured at substantially the same sampling time, with the corresponding identifiers of the vehicle. The second subset is designed i.e., created, or stated differently, generated, to support matching under conditions which more accurately reflect the situation in which the tracking system zx1 of the present disclosure will be used during run-time. Specifically, the second subset is designed to support a matching operation in which the student network 26 matches a vehicle visible in a smaller number of video frames than that present in the first subset and which was used by the teacher network (not shown) during a training period.

The gallery further includes variables of one or more bounding boxes in which each bounding box is positioned to substantially surround a vehicle visible in at least one of the Concatenate Members of a Concatenated Video Frame in the gallery. Furthermore, the gallery also includes corresponding identifiers of the vehicle or each visible vehicle. Accordingly, the first subset comprises the variables of the bounding box(es) enclosing each vehicle detected in a video frame of the first subset and identifiers of the vehicles. Similarly, the second subset comprises the variables of the bounding box(es) enclosing each vehicle detected in a video frame of the second subset and identifiers of the vehicles.

The training process for the teacher network (not shown) employs a first cost function comprising a summation of a triplet loss term and a classification loss term. The triplet loss term is a loss function in which a baseline (anchor) input is compared with a positive (true) input of the same class as the anchor and a negative (false) input of a different class to the anchor. The classification loss term (L_{CE}) is a cross-entropy loss denoted by L_{CE} = -y log ŷ where y and ŷ respectively represent the labels of the first subset (Tr_SS₁) and the output of the teacher network (not shown).

The objective of the training process is to minimise the first cost function. The triplet loss term can be minimized only when a network learns an internal representation, which ensures that a distance measured between the internal representations of a same vehicle even when viewed in different contexts (e.g. under different lighting conditions or positioned at different angles to an observing video camera) is very small, while the distance, or difference, between the internal representations of two different vehicles is as large as possible. By contrast, a classification loss is minimized only when the network outputs a correct label in response to a received image/video frame of a given vehicle.

The training process of the teacher network (not shown) establishes an internal representation which enables it to subsequently recognize a vehicle visible in a Concatenated Video Frame based on the vehicle’s physical appearance attributes. The teacher network (not shown) expresses its establishment of an internal representation of a vehicle’s appearance as a ranked list of identifiers for the vehicle, said ranked list comprising identifiers selected by the teacher network (not shown) from the first subset. The performance of the training process can therefore be assessed by computing a number of times the correct identifier for a vehicle, visible in a Concatenated Video Frame is among the first pre-defined number of identifiers returned by the teacher network (not shown) in response to that Concatenated Video Frame. Another metric i.e., method of assessing the performance of the training process can include computing, over the entire first subset, a number of times the first identifier, returned by the teacher network (not shown) in response to a given Concatenated Video Frame, is the correct identifier of the vehicle visible in that Concatenated Video Frame.

The goal of the training process for the student network 26 is to use the content of the second subset together with aspects of the internal representation formed by the teacher network (not shown), to enable the student network 26 to form its own internal representation of a vehicle’s physical appearance attributes, thereby allowing the student network 26 to subsequently recognize a vehicle visible in a video frame based on the vehicle’s physical appearance attributes. To this end, the training procedure for the student network 26 employs a second cost function comprising knowledge distillation terms and teacher network (not shown)-imposed terms as further described in Porrello A., Bergamini L. and Calderara S., Robust Re-identification by Multiple View Knowledge Distillation, Computer Vision, ECCV 2020, Springer International Publishing, European Conference on Computer Vision, Glasgow, August 2020. Specifically, the second cost function includes a weighted sum of a triplet loss term, a classification loss term, a knowledge distillation loss and an L2 distance term. The weights on the triplet loss term and the classification loss term are set at a value of 1, and the weights on the knowledge distillation loss and the L2 distance terms are separately configured prior to training.

The knowledge distillation loss is a cross entropy loss term expressing the difference between the identifier returned by the teacher network (not shown) in response to a Concatenated Video Frame and the identifier returned by the student network 26 in response to a Concatenated Video Frame comprising a subset of video frames from the Concatenated Video Frame given as input to the teacher network (not shown). Thus, the second cost function is formulated to cause the student network 26 to output a vector that closely approximates the vector outputted by the teacher network (not shown). Since the teacher network (not shown) is trained on a Concatenated Video Frame comprising a larger number of Concatenate Members, the teacher network (not shown) will establish appearance vectors containing more information. The second cost function causes the additional information to be distilled into the vectors outputted by the student network 26, even though the student network 26 does not receive as rich an input as the teacher network (not shown). The L2 distance term of the second cost function expresses the distance between the internal representation formed in the teacher network (not shown) and the internal representation formed in the student network 26. Specifically, since the teacher network (not shown) and the student network 26 have the same architectures, the L2 distance term is calculated based on the difference between the weights and associated parameters employed in the teacher network (not shown) and the corresponding weights and associated parameters employed in the student network 26.

Prior to their use in the gallery, images/video frames are processed to remove those that are very similar. This is done to increase the diversity of the images/ video frames and thereby to improve the generalization performance of the teacher network (not shown) and the student network 26. In addition, small images/ video frames (i.e. less than 50×50 pixels) and images/video frames whose height significantly exceeds their width may be eliminated as the quality and content of these images renders them less useful for training. The resulting images/ video frames are further pre-processed by resizing, padding, random cropping, random horizontal flipping and normalization. For example, regions of individual images/video frames may be randomly cropped therefrom to increase the diversity of the dataset. For example, an image/video frame of a car could be cropped into several different images, each of which captures different portions (comprising almost all) of the car, and all looking slightly different from each other. This will increase the robustness of the tracking system 1 to the diversity of viewed scenarios likely to be encountered in actual use i.e., during operation in real-time. Similarly, the images/video frames may be subjected to a random erasing operation in which some of the pixels in the image/video frame are erased. This may be used to simulate occlusion, so that the tracking system 1 becomes more robust to occlusion. In horizontal flipping, a vehicle (e.g. a car) in an image/video frame is flipped horizontally so that it faces to either the right or the left side of the image. Without horizontal flipping, the vehicles in the images used for training might all face in the same direction, in which case, the tracking system 1 could incorrectly learn that a vehicle will always face in a particular direction. In normalization, all of the features in an image are re-scaled to a value in the interval [-1, 1]. This helps the teacher network (not shown) and the student network 26 to more rapidly learn internal representations of the vehicles contained in the presented images.

Using the above training process, once suitably trained the student network 26 is used for subsequent real-time processing of video footage. In the case of the drive-through facility 200 (shown in FIG. 2), the video footage is captured by one or more video cameras (not shown) mounted in the drive-through facility 200.

The student network 26 is configured to establish an appearance vector for the detected vehicle, the appearance vector including a plurality of appearance attributes of the detected vehicle at the current time instance. Examples of the apperance attributes may include, but are not limited to, a colour, a size, a shape, a texture of the vehicle. The appearance vector is hereinafter also referred to as a detected appearance vector.

The student network 26 is configured to receive from the Cropper Module 12, Cropped Regions from the video footage VID. In particular, the student network 26 is configured to process a Cropped Region from a current video frame Fr(t_{c}) to produce therefrom a plurality of Detected Appearance Vectors A(t_{c}) = [α₁(t_{c}), α₂ (t_{c}) ... . . α_{ndav} (t_{c})]^{T} , ndav ≤ N_{Veh}(t_{c}) relating to the N_{Veh}(t_{c}) number of vehicles visible in the Cropped Region. A Detected Appearance Vector α_{ndav}(t_{c}), AV ≤ N_{Veh}(t_{c}) (wherein ||α_{ndav}(t_{c})|| = 1) is formed from the activation states of the neurons in the student network 26. Thus, a Detected Appearance Vector α_{ndav}(t_{c}) includes the physical appearance attributes of a given vehicle as internally represented by the student network 26. The student network 26 is further configured to transmit the plurality of Detected Appearance Vectors A(t_{c}) to the Matcher Module 20. The Matcher Module 20 is also communicatively coupled with the Tracking Database 24.

The Tracking Database 24 stores the plurality of tracklet vectors for corresponding plurality of previously detected vehicles. Each tracklet vector includes a plurality of previous appearance vectors of corresponding previously detected vehicles. Thus, the Tracking Database 24 includes a plurality of Tracklet records (hereinafter may also be referred to as tracklet vectors) including Previous Appearance vectors of a pre-defined number of the most recent historical observations of a previously detected vehicle. The Appearance Variables Extractor Module 14 is communicatively coupled with the Tracking Database 24 to transmit thereto the detected appearance vector of each detected vehicle from the first captured video frame, for use in populating the Tracking Database 24 with one or more initialised Tracklet records.

The Tracking Database 24 includes a Tracking Matrix TR ∈ ℝ^{N_{PSV}x(N_{αtt}×100)}. In an example, the Tracking Matrix includes a plurality of Tracklet Vectors Trⱼ(t_{c}) ∈ ℝ^{N_{αtt}×100}, j ≤ N_{PSV}. A tracklet is a fragment of a track followed by a moving object as constructed by an object recognition system. Given a current sampling time t_{c} and historical video footage VID = [Fr(tₚ)]_{D=0} _{to N-1} captured from a first sampling time τ until the current sampling time t_{c}, a Tracklet Vector Trⱼ(t_{c}) matrix includes 100 Previous Appearance Vectors PA^{k} ∈ ℝ^{N_{αtt}}, k ≤ 100, derived from the 100 most recent previous detections of a given previously detected vehicle. Each Previous Appearance Vector PA^{k} in turn comprises Nₐₜₜ Previous Appearance Attributes Pαₚ, p ≤ Nₐₜₜ, wherein a Previous Appearance Attribute includes a physical appearance attribute derived from a previous detection of a given vehicle.

The skilled person will understand that the above-mentioned number of 100 Previous Appearance Vectors PA^{k} in a Tracklet Vector Trⱼ(t_{c}) is provided for illustration purposes only. In particular, the scope of the present disclosure is in no way limited to the presence of 100 Previous Appearance Vectors PA^{k} in a Tracklet Vector Trⱼ(t_{c}). On the contrary, the Matcher Module 20 of the present disclosure is operable with any number of Previous Appearance Vectors PA^{k} in a Tracklet Vector Trⱼ(t_{c}) as may be empirically determined to permit the matching of a vehicle whose physical appearance attributes are contained in a Tracklet Vector Trⱼ(t_{c}) with a vehicle detected at a current sampling time t_{c}.

Given ϕ as the previous sampling time at which the j^{th} previously detected vehicle was last observed in the video footage; and, as previously mentioned, recognising that ϕ and the current sampling time may differ by more than one sampling interval, ideally, a Tracklet Vector Trⱼ(ϕ) of the given vehicle at the previous sampling time ϕ is described by Trⱼ(ϕ) = [PAⱼ(ϕ), PAⱼ (ϕ -Δt), ... , PAⱼ (ϕ - 99Δt)]. However, other configurations for a Tracklet Vector Trⱼ(ϕ) are also possible as described below:
a vehicle may not have been detected until less than 100 previous sampling intervals before the current sampling time (i.e. the vehicle may not have been detected until previous sampling time t_{c} - qΔt where q < 100), in which case, the Previous Appearance Attributes Pαₚ from the previous sampling times before the vehicle was first detected will be initialised to a value of zero in Tracklet Vector Trⱼ(ϕ) (e.g. for a vehicle first detected 20 previous sampling intervals before the current sampling time, the Tracklet Vector Trⱼ(ϕ) is denoted, by
$${\underline{T r}}_{j} \left(ϕ\right) = \left[{\underline{P A}}_{j} \left(ϕ\right) , {\underline{P A}}_{j} \left(ϕ - Δ t\right) , … , , {\underline{P A}}_{j} \left(ϕ - 19 Δ t\right) , \left[0\right] , \left[0\right] , \left[0\right] , … , \left[0\right]\right]$$
the view of a vehicle may have been obscured during one or more of the previous sampling times before ϕ, meaning that the Tracklet Vector Trⱼ(ϕ) of the vehicle may not include Previous Appearance Vectors PA^{k} from consecutive previous sampling times (e.g. view of a vehicle was obscured at previous sampling time ϕ — Δt, in which case the Tracklet Vector Trⱼ(ϕ) for the vehicle is denoted by Trⱼ(ϕ) = [PAⱼ(ϕ), PAⱼ(ϕ - 2Δt), ... , PAⱼ (ϕ - 99Δt), PAⱼ(ϕ - 100Δt) ]; and
at a given previous sampling time, a different vehicle with similar appearance may have been mistaken to be the vehicle whose movement is denoted by the Tracklet Vector Trⱼ(ϕ). For example, at previous sampling time ϕ — Δt, an o^{th} vehicle was mistaken to be a j^{th} vehicle, so that the Tracklet Vector Trⱼ(ϕ) for the j^{th} vehicle is denoted by Trⱼ(ϕ) = [PAⱼ(ϕ), PAₒ (ϕ - Δt), PAⱼ (ϕ - 2Δt), ... , PAⱼ(ϕ - 99Δt)] . Alternatively, the o^{th} vehicle continues to be mistaken as the j^{th} vehicle after previous sampling time ϕ — Δt, so that the Tracklet Vector Trⱼ(ϕ) for the j^{th} vehicle is denoted by Trⱼ(ϕ) = [PAⱼ(ϕ), PAₒ(ϕ) - Δt),PAₒ(ϕ) - 2Δt), ...,PAₒ(ϕ - 99Δt)]. This is an example of the identity switch problem. As is typical with use of conventionally designed tracking systems, an identity switch occurs when an object detector algorithm forms a poor internal representation of the physical appearance attributes of a studied vehicle. The tracking system 1 of the present disclosure aims to minimise the number of identity switches in a Tracklet Vector Trⱼ(ϕ) by substituting the Faster Region CNN (FrCNN) of the DeepSort algorithm with a VKD network which provides more robust and meaningful internal representations of physical appearance attributes.

To address the complexity posed by the timing of individual Previous Appearance Vectors in different Tracklet Vectors Trⱼ(ϕ), and for simplicity in understanding the present disclosure, a universal index k will be used henceforth to refer to individual Previous Appearance Vectors PA^{k} in a given Tracklet Vector, wherein Trⱼ(Φ) = {PA^{k} ∈ ℝ^{N_{αtt}}}, k ≤ 100 as per the foregoing example of 100 most recent previous detections of a given previously detected vehicle. Further, a corresponding record of the sampling times of each such indexed Previous Appearance Vector is maintained in a given Tracklet Vector.

The Tracking Database 24 is initially populated with Detected Appearance Vectors αⱼ(τ) j ≤ N_{Veh}(τ) calculated by the student network 26 in response to the first video frame Fr(τ) of the historical video footage. Thus, it can be seen that the Tracking Database 24 is an appearance-based counterpart for the dynamics/state-based Previous State Database 22. Indeed, since the Tracking Database 24 and the Previous State Database 22 are both populated according to the order in which vehicles are detected in a monitored area, the ordering of the Tracklet Vectors TRⱼ(ϕ), j ≤ N_{PSV} in the Tracking Database 24 matches that of the Previous State Vectors psⱼ(ϕ), j ≤ N_{PSV} in the Previous State Database 22. While the above discussion describes the Previous State Database 22 as being a separate component to the Tracking Database 24, the skilled person will understand that the scope of the present disclosure is not limited thereto. Rather, the skilled person will acknowledge that the Previous State Database 22 may be combined with the Tracking Database 24 into a single database component.

The State Predictor Module 18 is configured to transmit the Post-fit Residual Matrix Y(τ)^{T} and the Predicted Measurement vector (m̂(τ)) to the Matcher Module 20. Alternatively, in another embodiment, the State Predictor Module 18 may be configured to transmit each Predicted State vector (i.e. x̂ⱼ(τ)_{|τ}) to the Matcher Module 20.

The Matcher Module 20 is configured to calculate the difference between a detected appearance vector received from the Appearance Variables Extractor Module 14 and the Previous Appearance vectors of the Tracklet records in the Tracking Database 24, to permit matching between the currently detected vehicle, and a previously detected vehicle. The Matcher Module 20 is further communicatively coupled with the Previous State Database 22 and the Tracking Database 24 to deliver appropriate updates thereto on successful matching of a detected vehicle from a current captured video frame with a previously detected vehicle, or failure to find a matching, i.e. wherein the vehicle detected in a current video frame is previously unseen.

The Matcher Module 20 includes a Motion Cost Module 28, an Appearance Cost Module 30 and, an Intersection over Union (IoU) Module 32, each of which are communicatively coupled with a Combinatorial Maximiser Module 34. The Combinatorial Maximiser Module 34 is further communicatively coupled with an Update Module 36, wherein the Update Module 36 is itself communicatively coupled with the Previous State Database 22 and the Tracking Database 24.

The Motion Cost Module 28 is configured to calculate a first cost value being the squared Mahalanobis distance Δ_{M} matrix representing the squared distance

$$\left({δ}_{i , j}^{M}\right)$$

between a given Actual Measurement Vector zₙₐₘᵥ (t_{c}) of the detected vehicle and a Predicted Measurement Vector (m̂ⱼ(t_{c})), The Predicted Measurement Vector (m̂ⱼ(t_{c})) may either have been received from the State Predictor Module 18 or may have been calculated from a Predicted State x̂ⱼ(t_{c})_{|tc} received from the State Predictor Module 18 (using the expression (m̂ⱼ(t_{c})) = H_{t_{c}}x̂ⱼ(t_{c})_{|t_{c}}). The computation carried out by the Motion Cost Module 28 is mathematically expressed by:

$${Δ}_{M} = Y {\left({t}_{c}\right)}^{T} {S}_{M} Y \left({t}_{c}\right)$$

where S_{M} is the covariance matrix of Y(t_{c}).

State estimation uncertainty is addressed by measuring how many standard deviations the Actual Measurement Vector zₙₐₘᵥ (t_{c}) is from the Predicted Measurement Vector (m̂ⱼ(t_{c})), Since a Predicted State Vector x̂ⱼ(t_{c})_{|t_{c}} is calculated from a Previous State Vector psⱼ(ϕ) (by way of a Detection State Vector (x̂(γ)_{|γ-1})) an unlikely association of a given Actual Measurement Vector zᵢ(t_{c}) with a given Previous State Vector psⱼ(ϕ) can be excluded, by thresholding the Mahalanobis distance Δ_{M} at, for example, a 95% confidence interval calculated from the X² distribution. Mahalanobis distance Δ_{M} may be hereinafter referred to a first cost threshold, and the first cost threshold may be used to identify the detected vehicle as a previously detected first vehicle. For example, if the Mahalanobis distance Δ_{M} between the actual measurement vector and the predicted measurement vector of the previously detected first vehicle is negligeable, and is less than the first cost threshold, then the detected vehicle may be identified as the previously detected first vehicle. Also, the first cost threshold may be used to form an excluded pair, such as a first excluded pair of the detected vehicle and a previously detected second vehicle, when the first cost value for the previously detected second vehicle is more than the first cost threshold. This means, that the detected vehicle may never be identified as the previously detected second vehicle.

Specifically, by implementing this thresholding function (Th^{(M)}), the motion cost module 28 populates a State Indicator matrix SI ∈ ℝ^{N_{Veh}(τ)xN_{PV}} with binary values SI_{i,j}. An entry SI_{i,j} is valued at one if

$${δ}_{i , j}^{M} \leq T {h}^{\left(M\right)}$$

and denotes that the association of Actual Measurement Vector zₙₐₘᵥ (t_{c}) with Previous State Vector psⱼ(ϕ) is admissible for matching by the Combinatorial Maximiser Module 34. By contrast an entry SI_{i,j} is valued at zero if

$${δ}_{i , j}^{M} \leq T {h}^{\left(M\right)}$$

and denotes a pairing of currently detected vehicle with a previously detected vehicle that is not admissible for matching by the Combinatorial Maximiser Module 34. In other words, a pairing of currently detected vehicle with a previously detected vehicle that has a corresponding entry in the State Indicator Matrix valued at zero, is excluded from matching by the Combinatorial Maximiser Module 34, such a pairing will be referred to henceforth as a First Excluded Pairing.

The Mahalanobis distance Δ_{M} metric used in the Motion Cost Module 28 is useful for matching of vehicles between video frames separated by a few seconds. However, for video frames separated by longer periods (e.g. if a vehicle is occluded for a longer period), the motion-based predictive approach of the Motion Cost Module 28 may no longer be sufficient; and a comparative analysis of vehicles in different video frames based on the vehicles’ appearance may become necessary. This is the premise for the Appearance Cost Module 30 as will be discussed hereinafter.

The Appearance Cost Module 30 is configured to receive from the student network 26, each of a plurality of Detected Appearance Vectors A(t_{c}) = [α₁(t_{c}), α₂(t_{c}) ... . . α_{ndav}(t_{c}))]^{T}, ndav ≤ N_{Veh}(t_{c}) of each and every vehicle detected in a given video frame Fr(t_{c}). The Appearance Cost Module 30 is further configured to retrieve from the Tracking Database 24, each of a plurality of Tracklet Vectors Trⱼ(ϕ) ∈ ℝ^{N_{αtt}×100}, j ≤ N_{PSV} in which each Tracklet Vector includes the Previous Appearance Vectors PA^{k} ∈ ℝ^{N_{αtt}}, k ≤ 100 derived from each of the most recent 100 previous observations of a same previously detected vehicle (where Nₐₜₜ is the number of physical appearance attributes derived from a single observation of the previously detected vehicle).

The Appearance Cost Module 30 is configured to calculate a second cost value being a minimum cosine distance

$$\left({δ}_{i , j , k}^{A}\right)$$

between the Detected Appearance Vector of an i^{th} vehicle detected at current sampling time t_{c} and the Previous Appearance Attributes of every Previous Appearance Vector in a j^{th} Tracklet Vector.

$${δ}_{i , j , k}^{A} = m i n \left(1 - {\underline{α}}_{i} {\left({t}_{c}\right)}^{T} {\underline{P A}}_{j}^{k}\right) , k \leq 100$$

In a manner of computation analogous to that carried out by the Motion Cost Module 28, the Appearance Cost Module 30 also employs a threshold operation on the minimum cosine distance

$$\left({δ}_{i , j , k}^{A}\right)$$

to exclude an unlikely association of the Detected Appearance Vector (αⱼ(t_{c})) of a given vehicle with a given Previous Appearance Vector PA^{k} in a given Tracklet Vector Trⱼ(ϕ) in the Tracking Database 24. For instance, by implementing this thresholding function (Th^{(A)}), an Appearance Indicator Matrix AI ∈ ℝ^{N_{Veh}(t_{c})xN_{PSV}} is populated with binary valued entries AI_{i,j}.

An entry AI_{i,j} is valued at one if

$${δ}_{i , j}^{A} \leq T {h}^{\left(A\right)}$$

and denotes that the association of Detected Appearance Vector (αⱼ(t_{c})) with Previous Appearance Vector PA^{k} is admissible for matching by the combinatorial maximisation algorithm in the Combinatorial Maximiser Module 34. By contrast, an entry AI_{i,j} is valued at zero if

$${δ}_{i , j}^{A} > T {h}^{\left(A\right)}$$

and denotes that a pairing of currently detected vehicle with a previously detected vehicle that is not admissible for matching by the Combinatorial Maximiser Module 34. In other words, a pairing of currently detected vehicle with a previously detected vehicle wherein the pairing has an entry in the Appearance Indicator Matrix valued at zero are excluded from matching by the Combinatorial Maximiser Module 34, such a pairing will be referred to henceforth as a Second Excluded Pairing.

The variable used for thresholding the minimum cosine distance

$$\left({δ}_{i , j , k}^{A}\right)$$

may be hereinafter referred to a second cost threshold, and the second cost threshold may be used to form a second excluded pair of the detected vehicle and a previously detected third vehicle. For example, when the second cost value for the previously detected third vehicle is more than the second cost threshold, this means, that the appearance vectors of the detected vehicle and the previously detected third vehicle are very different from each other, and the detected vehicle may never be identified as the previously detected third vehicle.

The IoU Module 46 is configured to receive from the State Predictor Module 18 an Actual Measurement Vector zₙₐₘᵥ (t_{c}) and corresponding Predicted Measurement Vectors (m̂ⱼ(t_{c}),j ≤ N_{PSV}). The IoU Module 46 is further configured to calculate an intersection over union (IoU) measurement between the Actual Measurement Vector zₙₐₘᵥ (t_{c}) and each Predicted Measurement Vector m̂ⱼ (t_{c}), using the method of the DeepSORT algorithm. The IoU Module 46 is further configured to employ a thresholding operation on the minimum IoU value, to exclude an unlikely association of a bounding box vector bᵢ(t_{c}) calculated from a received video frame Fr(t_{c}) (contained in the Actual Measurement Vector zₙₐₘᵥ(t_{c})) and a predicted bounding box calculated from predicted system dynamics (represented by the Predicted Measurement Vector (m̂ⱼ(t_{c})),

The Combinatorial Maximiser Module 34 is configured to receive the minimum cosine distance

$$\left({\text{δ}}_{\text{i,j,k}}^{\text{A}}\right)$$

from the Appearance Cost Module 30, and squared Mahalanobis distance

$$\left({\text{δ}}_{\text{i,j}}^{\text{M}}\right)$$

from the Motion Cost Module 28. In other words, the Combinatorial Maximiser Module 34 is configured to receive the plurality of first cost values from the motion cost module 28, and the plurality of second cost values from the appearance cost module 30.

The Combinatorial Maximiser Module 34 is configured to calculate a weighted sum of the plurality of first and second cost values, for example, the weighted sum of the minimum cosine distance

$$\left({\text{δ}}_{\text{i,j,k}}^{\text{A}}\right)$$

and the squared Mahalanobis distance

$$\left({\text{δ}}_{\text{i,j}}^{\text{M}}\right)$$

using a weighting variable λ which is initially set to a pre-defined value (which is typically a very small value, for example 10-6 to provide less emphasis on the Kalman filter contribution to the matching process) and later tuned as appropriate for the relevant use case.

$${c}_{i , j} = λ {δ}_{i , j}^{M} + \left(1 - λ\right) {δ}_{i , j , k}^{A}$$

The Combinatorial Maximiser Module 34 is further configured to populate an Association Matrix with values formed from the product of the corresponding binary variables of the State Indicator Matrix SI ∈ ℝ^{N_{Veh}(t_{c})xN_{PSV}} and the Appearance Indicator Matrix AI ∈ ℝ^{N_{Veh}(t_{c})xN_{PSV}} An association between a currently detected i^{th} vehicle and the state/dynamics and appearance of a previously detected j^{th} vehicle is admissible for matching by a combinatorial maximisation algorithm such as the Hungarian/Kuhn Munkres algorithm (as described in Kuhn H.W., “The Hungarian method for the assignment problem”, Naval Research Logistics Quarterly, 1955 (2) 83-97) if the corresponding binary variable in the Association Matrix is valued at 1. The combinatorial maximisation algorithm is implemented to determine matchings between admissible pairs of currently detected i^{th} vehicles and previously detected j^{th} vehicles on the basis of the weighted sum. The matchings of currently detected i^{th} vehicles and previously detected j^{th} vehicles will be referred to henceforth as a First Pairing.

In the event a currently detected i^{th} vehicle cannot be matched with a j^{th} previously detected vehicle because the pairing of the i^{th} currently detected vehicle with every j^{th} Tracklet Vector Trⱼ(ϕ) is a Second Excluded Pairing, any Tracklet Vector Trⱼ(ϕ) that has not been matched with a vehicle detected during a pre-defined number of previous sample times are selected, to form a plurality of Unmatched Tracklet Vectors UTrⱼ(ϕ). The Combinatorial Maximiser Module 34 is then configured to implement a further iteration of the combinatorial maximisation algorithm to determine matchings of unmatched currently detected i^{th} vehicles to each of the Unmatched Tracklet Vectors UTrⱼ(ϕ).

With this process, the Combinatorial Maximiser Module 34 is configured to sort the Unmatched Tracklet Vectors UTrⱼ(ϕ) in ascending order according to their age. For instance, the Unmatched Tracklet Vectors UTrⱼ(ϕ) are ordered according to the elapsed time (qΔt) between a current sampling time t_{c} and the previous sampling time ϕ at which a vehicle corresponding with the Unmatched Tracklet Vector was last observed. For sake of brevity and simplicity in understanding this disclosure, this elapsed time (qΔt = t_{c} - ϕ) will henceforth be referred to as the age of the Unmatched Tracklet Vector UTrⱼ(ϕ). Stated differently, an Unmatched Tracklet Vector UTrⱼ(ϕ) where the elapsed time between the current sampling time and the sampling time at which a vehicle corresponding with the Unmatched Tracklet Vector was last observed, is one sampling interval Δt, will be referred to as an Unmatched Tracklet Vector UTrⱼ(ϕ) of age one sample. Similarly, an Unmatched Tracklet Vector UTrⱼ(ϕ) where the elapsed time between the current sampling time and the sampling time at which a vehicle corresponding with the Unmatched Tracklet Vector was last observed, is two sampling intervals 2Δt, will be referred to as having an age of two samples, and so forth.

The combinatorial maximisation algorithm is implemented to determine matchings of an unmatched currently detected i^{th} vehicle to each j^{th} Unmatched Tracklet Vector UTrⱼ(ϕ) in order of increasing age of the Unmatched Tracklet Vector UTrⱼ(ϕ). That is, the Combinatorial Maximiser Module 34 is configured to select each of the Unmatched Tracklet Vectors UTrⱼ(ϕ) of age one sample and attempt to find a matching of the currently detected i^{th} vehicle therewith. The Combinatorial Maximiser Module 34 is configured to form a first pairing between the detected vehicle and a previously detected fourth vehicle, based on the weighted sum, which means identifying the detected vehicle as the previously detected fourth vehicle.

In the event a match is not found, the Combinatorial Maximiser Module 34 is configured to select each of the Unmatched Tracklet Vectors UTrⱼ(ϕ) whose age is two samples and attempt to find a matching of the currently detected i^{th} vehicle therewith. This process is repeated for a pre-determined maximum number of ages (Amax) of the Unmatched Tracklet Vectors UTrⱼ(ϕ). In each iteration of this process, the combinatorial maximisation algorithm of the Combinatorial Maximiser Module 34 is implemented to determine matchings between the Unmatched Tracklet Vectors UTrⱼ(ϕ)) of the relevant age and the unmatched currently detected i^{th} vehicle on the basis of the minimum cosine distance between the Detected Appearance Vector of the unmatched currently detected i^{th} vehicle and each Previous Appearance Vector in each such Unmatched Tracklet Vector UTrⱼ(ϕ). The matching between the unmatched currently detected i^{th} vehicle and the previously detected vehicle corresponding with an Unmatched Tracklet Vector UTrⱼ(ϕ)) of the relevant age will be referred to henceforth as a Second Pairing.

A given iteration of this process will not override an existing matching, as an Unmatched Tracklet Vector UTrⱼ(ϕ) under consideration during the iteration will have a different age to the Unmatched Tracklet Vectors UTrⱼ(ϕ) considered during a previous iteration. Furthermore, any currently detected i^{th} vehicles that have been matched during a given iteration will be excluded from consideration during subsequent iteration. In taking this approach, it is assumed that Unmatched Tracklet Vectors UTrⱼ(ϕ) of least age are likely to be more similar to a given currently detected i^{th} vehicle than older Unmatched Tracklet Vectors UTrⱼ(ϕ).

In the context of the present disclsoure, the Combinatorial Maximiser Module 34 may implement a counter having a maximum counter threshold equal to the pre-determined maximum number of ages (Amax) to perform the matching of the detected vehicle with previously detected vehicles, based on age of their corresponding tracklet vectors.

The Combinatorial Maximiser Module 34 is further configured to receive a third cost value as the intersection over union (IoU) measurements from the IoU Module 46 and to use the intersection over union (IoU) measurements to determine matchings from the remaining pairs of unmatched currently detected i^{th} vehicles and remaining Unmatched Tracklet Vectors UTrⱼ(ϕ) of a selected age, for example, age 1 sample, the said remaining pairs of unmatched currently detected i^{th} vehicles and remaining Unmatched Tracklet Vectors UTrⱼ(ϕ) being those that are not in the First Pairings or the Second Pairings. For brevity, an Unmatched Tracklet Vector of a selected age and corresponding with a previously detected vehicle that is not contained in the First Pairing or the Second Pairing will be referred to henceforth as a Remaining Unmatched Tracklet Vector. Similarly, a currently detected vehicle that is not contained in the First Pairing or the Second Pairing will be referred to henceforth as a Remaining Currently Detected Vehicle. The matching between a Remaining Currently Detected i^{th} Vehicle and a previously detected vehicle represented by a Remaining Unmatched Tracklet Vector UTrⱼ(ϕ) will be referred to henceforth as a Third Pairing. Further, the First Pairing, Second Pairing and Third Pairing will collectively be referred to henceforth as the Collective Pairing.

The Combinatorial Maximiser Module 34 is configured to transmit a plurality of first matching indices i and second matching indices j to the Update Module 36, the first and second matching indices i and j representative of the matching currently detected vehicles, Remaining Currently Detected Vehicles and corresponding Tracklet Vectors, Unmatched Tracklet Vectors and Remaining Unmatched Tracklet Vector respectively of the Collective Pairing. In the context of the present disclosure, the Combinatorial Maximiser Module 34 transmits various pairs of the detected vehicle and the previously detected vehicles.

The Update Module 36 is configured to transmit to the Previous State Database 22, Actual Measurement Vectors zₙₐₘᵥ(t_{c}) together with different instructions depending on whether the index of a given Actual Measurement Vector zₙₐₘᵥ(t_{c}) matches a first matching index. For instance, if an index of a given Actual Measurement Vector zₙₐₘᵥ(t_{c}) matches a first matching index, the instructions transmitted by the Update Module 36 comprise an instruction to activate the State Predictor Module 18 to compute a new Predicted State Vector x̂ⱼ(t_{c})_{|tc} using the matching Previous State Vector. The instructions further provide that the Previous State Vector psⱼ(ϕ) whose index matches the second matching index is to be updated with the given Actual Measurement Vector zₙₐₘᵥ(t_{c}) (and the first derivative components (u′, v′, s′ and r′) of the Previous State Vector psⱼ(ϕ) is to be updated with those of the new Predicted State Vector x̂ⱼ(t_{c})_{|t_{c}}). In contrast, in the event an index of a given Actual Measurement Vector zₙₐₘᵥ(t_{c}) does not match a first matching index, the instructions transmitted by the Update Module 36 comprise an instruction to add a new Previous State Vector ps_{j(ϕ)} to the Previous State Database 22. The new Previous State Vector ps_{j(ϕ)} denoted by ps_{j(ϕ)} = [zₙₐₘᵥ(t_{c}), ᵤ’, ᵥ’, s′, r′]^{T} comprises the Actual Measurement Vector zₙₐₘᵥ(t_{c}) and wherein the first derivative terms (u′, v′ s′ and r′) may be initialised to a value of zero.

The Update Module 36 is configured to transmit to the Tracking Database 24, each of a plurality of Detected Appearance Vectors A(t_{c}) = [α₁(t_{c}),α₂(t_{c}) ... . . α_{ndav}(t_{c})]^{T} ndav ^{≤} Nᵥₑₕ(t_{c}) of each vehicle detected in a current video frame Fr(t_{c}), together with different instructions depending on whether the index of a given Detected Appearance Vector α_{ndav}(t_{c}) matches a first matching index. If an index of a given Detected Appearance Vector α_{ndav}(t_{c}) matches a first matching index, the instructions transmitted by the Update Module 36 comprise an instruction to add the Detected Appearance Vector α_{ndav}(t_{c}) to the Tracklet Vector Trⱼ(ø) whose index matches the second matching index. Specifically, the instruction includes an instruction to insert the Detected Appearance Vector α_{ndav}(t_{c}) as the first Previous Appearance Vector PA¹ and to delete the last Previous Appearance Vector PA¹⁰⁰ of the Tracklet Vector Trⱼ(ø). In contrast, if an index of a given Detected Appearance Vector α_{ndav}(t_{c}) does not match a first matching index, the instructions transmitted by the Update Module 36 include an instruction to add a new Tracklet Vector Trⱼ(ø) to the Tracking Database 24. For instance, the first Previous Appearance Vector PA¹ of the new Tracklet Vector Trⱼ(ø) may include the Detected Appearance Vector α_{ndav}(t_{c}) .

On receipt of the instructions, the Previous State Database 22 and the Tracking Database 24 are also configured to review the age of its Previous State Vectors psⱼ(ø) and corresponding Tracklet Vectors Trⱼ(ø). The age of a Tracklet Vector Trⱼ(ø) is denoted as the elapsed time (qΔt = t_{c} - ø) between a current sampling time t_{c} and the sampling time at which a vehicle corresponding with the Tracklet Vector was last observed (i.e the sampling time of the first Previous Appearance Vector PAⱼ(ø) or PA¹ of the Tracklet Vector Trⱼ(ø)). In the event the age of a Tracklet Vector Trⱼ(_{τ}) exceeds a pre-defined number of sampling intervals, the Previous State Database 22 and the Tracking Database 24 are configured to delete the Tracklet Vector Trⱼ(ø) and corresponding Previous State Vector psⱼ(ø). In this way, the Previous State Database 22 and the Tracking Database 24 are cleansed of records of vehicles that have left the observed area, to prevent the accumulation of unnecessary records therein and thereby control the storage demands of the tracking system 1 over time in busy environments.

In operation, the tracking system 1 implements a set-up phase, an image receipt and pre-processing phase, and a main processing phase. The set-up phase includes pre-training the teacher Network (not shown) and the student network 26 of the Appearance Variables Extractor Module 14, pre-establishing the state transition matrix and measurement matrix of the State Predictor Module 18, pre-establishing the values of the first cost threshold, the maximum counter threshold and the maximum historical age. The image receipt and pre-processing phase includes the steps of receiving a video frame (F(τ) from video footage captured by a video camera, and pre-processing the video frame F(τ). Upon completion of the set-up phase, and the image receipt and pre-processing phase, the main processing phase is repeatedly implemented in a series of cyclic iterations using successively captured video frames. The main processing phase has been explained in detail with reference to FIG. 3C. Referring to FIG. 2, the drive-through facility 200 includes an elongate rail unit 202 mountable on a plurality of substantially equally spaced upright post members 204. The drive-through facility 200 includes one or more customer engagement devices 206. A customer engagement device 206 includes a display unit 208. The display unit is mountable on a housing unit 210. The housing unit 210 is in a slidable engagement with the elongate rail unit 202. The rail unit 202 may be provided with a plurality of markings or other indicators (not shown) mounted on, painted on or otherwise integrated into the rail unit 202. The markings or indicators are spaced apart along the length of the rail unit 202. The markings or indicators are positioned to permit a corresponding sensor (not shown) contained in the housing unit 210 mounted on the rail unit 202, to determine the housing unit’s 210 location, relative to either of both ends of the rail unit 202. In this way, the housing unit 210 is configured to determine how far it has travelled along the rail unit 202 at any given time, in response to a received navigation instruction.

In use, one or more customer vehicles 212 may be driven from an entrance (not shown) adjoining a perimeter of the drive-through facility for entry into the drive-through facility and thereafter be driven along the service lane arranged in parallel with the rail order-taking system of the drive-through facility 200. Further, one or more customer engagement devices 206 mounted on the rail unit 202 may be arranged such that the display unit(s) (not shown) of each customer engagement device 206 faces out towards the service lane. As disclosed earlier herein, the customer engagement device 206 is movable along the rail unit 202 and may therefore, be operable to interface, for example, by fulfilling one or more orders of a customer present within a given vehicle 212.

Upon entry of the customer vehicle 212 into the drive-through facility i.e., onto the service lane of the drive-through facility, the location of the vehicle 212 relative to the rail unit 202 is detected by one or more video cameras mounted on the upright post members 204 of the rail unit 202 and/or by other video cameras that may be additionally installed at various other locations within the drive-through facility, such as at an entrance to the drive-through facility or at an exit from the drive-through facility. The customer engagement device 206 is moveable along the rail unit 202 while the pertinent display unit(s) faces towards a driver’s, or front passenger’s, window of the customer vehicle 212. In such a scenario, the tracking system 1 of the present disclosure is operable to continuously track the movements of the customer vehicle 212 and to adjust the movements of the customer engagement device 206 accordingly, so that the occupants i.e., driver or passenger(s) of the vehicle are provided with an ongoing dedicated and seamless customer service by the customer engagement device 206 irrespective of the movements of the customer vehicle 212.

FIG. 3A depicts a flowchart of a method 300 for tracking of object(s) and for realizing functional aspects of the tracking system 1, in accordance with an embodiment of the present disclosure. This method may be a computer implemented method.

Referring to FIG. 3A together with FIG. 1, the method 300 of the present disclosure includes a set-up phase 302a, an image receipt and pre-processing phase 302b, and a main processing phase 302c. On completion of the set-up phase 302a, the image receipt and pre-processing phase 302b and main processing phase 302c are repeatedly implemented in a series of cyclic iterations using successively captured video frames. Terminology and abbrevations referred to in relation to FIGS. 3A and 3B are equivalent to that as referred to in relation to FIG. 1..

The set-up phase 302a includes the steps of pre-training the teacher Network (not shown) and the student network 26 of the Appearance Variables Extractor Module 14, pre-establishing the state transition matrix and measurement matrix of the State Predictor Module 18, pre-establishing the values of a first cost threshold, a maximum counter threshold and a maximum historical age.

The image receipt and pre-processing phase 302b includes the steps of receiving a video frame (F(τ) from video footage captured by a video camera, and pre-processing the video frame F(τ).

FIGS. 3B-3D explains the main processing phase 302c in detail. At step 304, the method 300 includes establishing a bounding box bᵢ(t_{c}) around each currently detected vehicle. As disclosed earlier herein, the Detector Module 10 processes a pre-processed current video frame Fr(t_{c}) to detect one or more vehicles that are visible in the current video frame Fr(t_{c}) of a video footage. The vehicle(s) detected in the current video frame Fr(t_{c}) are referred to henceforth as currently detected vehicles. In the process of detecting a vehicle that is visible in the current video frame, the Detector Module 10 establishes a bounding box bᵢ(t_{c}) around the currently detected vehicle.

At step 306, the method 300 includes establishing a plurality of Detected Appearance Vectors A(t_{c}) of the currently detected vehicle(s) encompassed by the bounding box(es) B(t_{c}). Each Detected Appearance Vector A(t_{c}) indicates a physical appearance attribute of a currently detected vehicle. As disclosed earlier herein, the student network 26 of the Appearance Variables Extractor Module 14 processes the pre-processed video frame Fr(t_{c}) to establish a plurality of Detected Appearance Vectors A(t_{c}) of the currently detected vehicle(s) encompassed by the bounding box(es) B(t_{c}).

At step 308, the method 300 includes calculating a current Measurement vector zᵢ(t_{c}) from the bounding box bᵢ(t_{c}) of the currently detected vehicle. The current measurement vector may be hereinafter also referred to as actual measurement vector of the detected vehicle. The current measurement vector includes horizontal and vertical locations of the centre of the bounding box at the current time instance.

At step 310, the method 300 includes retrieving one or more Previous State vectors psⱼ(ø) from the Previous State Database 22. The previous state vector psⱼ(ø) is derived based on most recent detection of previously detected vehicles detected at time instances preceding the current time instance. Each Previous State Vector psⱼ(ø) is derived from a detection of a previously detected vehicle. The sampling time of the Previous State Vector psⱼ(ø) is the sampling time at which the vehicle was last detected before the current sampling time.

At step 312, the method 300 includes calculating a plurality of Predicted Measurement vectors (m̂ⱼ(τ)) for corresponding plurality of previously detected vehicles based on the Previous State vector psⱼ(ø) using a Kalman filter algorithm.

At step 314, the method 300 includes calculating a first cost value

$${δ}_{i , j}^{M}$$

being a squared Mahalanobis distance between the current Measurement vector zᵢ(τ) and a Predicted Measurement vector (m̂ⱼ(_{τ})) of each previously detected vehicle. In an embodiment of the present disclosure, the first cost value

$$\left({δ}_{i , j}^{M}\right)$$

for may be compared with a first cost threshold to determine if the detected vehicle can be identified as a previously detected first vehicle.

At step 316, the method 300 includes retrieving, from the Tracking Database 24, a plurality of Tracklet vectors Trⱼ(τ) corresponding to the plurality of previously detected vehicles. Each tracklet vector includes a plurality of previous appearance vectors of corresponding previously detected vehicle representative of its multiple previous observations at multiple time instances preceding the curren time of the currently detected vehicle, wherein each previous appearance vector includes a plurality of previous appearance attributes of the previously detected vehicle.

At step 318, the method 300 includes calculating a plurality of second cost value

$${δ}_{i , j , k}^{A} ,$$

the second cost value

$${δ}_{i , j , k}^{A}$$

being a minimum cosine distance between the current appearance vector A(τ) and a previous appearance attribute of a tracking appearance vector in the Tracklet vector of a previously detected vehicle.

At step 320, the method 300 includes establishing a weighted sum of the plurality of the first and second cost values.

At step 321, the method 300 includes using the weighted sum in a combinatorial maximisation algorithm to establish a First Pairing between a currently detected vehicle and a previously detected vehicle. Thereafter, the method moves to step 450.

In an embodiment, at the step 314 of calculating a first cost value

$${\text{δ}}_{\text{i,j}}^{\text{M}}$$

being a squared Mahalanobis distance between the Actual Measurement Vector zₙₐₘᵥ(t_{c}) and the Predicted Measurement Vector (m̂ⱼ(t_{c})) of the currently detected vehicle, the method 300 may additionally, or optionally, include establishing a First Excluded Pairing comprising an index of the currently detected vehicle and an index of the previously detected vehicle whose first cost value

$${\text{δ}}_{\text{i,j}}^{\text{M}}$$

exceeds the first cost threshold.

Additionally, or optionally, at the step 318 of calculating a second cost value

$${\text{δ}}_{\text{i,j,k}}^{\text{A}}$$

being a minimum cosine distance between a Detected Appearance Vector A(t_{c}) of the currently detected vehicle and the Previous Appearance Attributes of a previously detected vehicle, the method 300 may further include establishing a Second Excluded Pairing comprising an index of the currently detected vehicle and an index of the previously detected vehicle whose second cost value

$${\text{δ}}_{\text{i,j}}^{\text{A}}$$

exceeds the second cost threshold.

Additionally, or optionally, the step 321 of using the weighted sum in a combinatorial maximisation algorithm to establish a First Pairing between a currently detected vehicle and a previously detected vehicle, may further include using the weighted sum in a combinatorial maximisation algorithm to establish from those currently detected vehicles and previously detected vehicles whose indices are not contained in the First Excluded Pairing(s) or Second Excluded Pairing(s), a First Pairing between those currently detected vehicles and previously detected vehicles.

At step 322, the method 300 includes determining if a currently detected vehicle has not been matched with a previously detected vehicle on account of its index being in the Second Excluded Pairing. If no indices of currently detected vehicles are in the Second Excluded Pairing, then the matching operation ends because all the currently detected vehicles have been matched with a previously detected vehicle; and the method 300 moves to step 350. However, if the index of a currently detected vehicle is in the Second Excluded Pairing, and as a consequence, the currently detected vehicle has not been matched with a previously detected vehicle, the method 300 moves to step 324.

At step 324, the method 300 includes selecting any Tracklet Vector Trⱼ(ø) that has not been matched with a vehicle detected during a pre-defined number of previous sample times; and collating the selected Tracklet Vectors to form a plurality of Unmatched Tracklet Vectors UTrⱼ(ø).

At step 326, the method 300 includes setting an age threshold to a value of one sample and a counter to a value of one. The term “age” refers to the elapsed time (qΔt) between a current sampling time t_{c} and the previous sampling time ø at which a vehicle corresponding with the Unmatched Tracklet Vector was last observed. At step 328, the method 300 includes checking if the counter is less than a maximum counter threshold.

As shown at step 330, the method 300 includes selecting each Unmatched Tracklet Vector that has an age equal to the age threshold. At step 332, the method 300 includes using the minimum cosine distance between the Detected Appearance Vector of the currently detected i^{th} vehicle and each Previous Appearance Vector in each such selected Unmatched Tracklet Vector UTrⱼ(ø) in a combinatorial maximisation algorithm to establish a Second Pairing between the currently detected vehicle and a previously detected vehicle corresponding to a selected Unmatched Tracklet Vector.

At step 334, the method 300 includes checking if the Second Pairing is established. If the Second Pairing is established, then it means that the currently detected vehicle matches with a previously detected vehicle, and the method 300 moves to step 304. Otherwise, the method 300 moves to step 336.

At step 336, the method 300 includes increasing the age threshold by one sample and incrementing the counter by one, and steps 328-334 are performed iteratively until the counter exceeds the maximum counter threshold.

When the counter value exceeds the maximum counter threshold, then at step 338, the method 300 includes selecting an an Unmatched Tracklet Vector whose age is one and which is not contained in the First Pairing or the Second Pairing and calculating a third cost value being an intersection over union (IoU) between an Actual Measurement Vector zₙₐₘᵥ(t_{c}) of a currently detected vehicle that is not contained in the First Pairing or the Second Pairing and a Predicted Measurement Vector m̂ⱼ(t_{c}) calculated from a Previous State Vector psⱼ(ø) corresponding with the selected Unmatched Tracklet Vector. For brevity, an Unmatched Tracklet Vector whose age is one and corresponds with a previously detected vehicle that is not contained in the First Pairing or the Second Pairing will be referred to henceforth as a Remaining Unmatched Tracklet Vector. Similarly, a currently detected vehicle that is not contained in the First Pairing or the Second Pairing will be referred to henceforth as a Remaining Currently Detected Vehicle.

At step 340, the method 300 includes establishing a Third Pairing between a Remaining Currently Detected Vehicle and the previously detected vehicle corresponding to a Remaining Unmatched Tracklet Vector, by using the third cost value in a combinatorial maximisation algorithm. The First Pairing, Second Pairing and Third Pairing will collectively be referred to henceforth as the Collective Pairing.

At step 350, the method 300 includes updating the Previous State Database 22. As disclosed earlier herein, the Update Module 36 updates the Previous State Database 22 by
(a) updating in the Previous State Database 22 the Previous State Vector psⱼ(ø) whose index matches that of the corresponding Tracklet Vector, Unmatched Vector or Remaining Unmatched Vector in the Collective Pairing, with an Actual Measurement Vector zₙₐₘᵥ(t_{c}) whose index matches that of a currently detected vehicle or Remaining Currently Detected Vehicle of the Collective Pairing and the first derivative terms of a new Predicted State Vector x̂(t_{c})_{|tc} calculated from the Previous State Vector psⱼ(ø) using a Kalman filter algorithm;
(b) adding to the Previous State Database 22 a new Previous State Vector psⱼ(ø) formed from an Actual Measurement Vector zₙₐₘᵥ(t_{c}) whose index does not match the index of a currently detected vehicle or Remaining Currently Detected Vehicle of the Collective Pairing and wherein the first derivative terms of the new Previous State Vector psⱼ(ø) are set to an initial value of zero; and
(c) deleting from the the Previous State Database 22, Previous State Vectors psⱼ(ø) corresponding with Tracklet Vectors Trⱼ(τ) in the Tracking Database 24 whose ages exceed a maximum historical age.

As shown at step 352, the method 300 also includes updating the Tracking Database 24. As disclosed earlier herein, the Update Module 36 updates the Tracking Database 24 by:
a) amending a Tracklet Vector Trⱼ(ø) whose index matches that of a Tracklet Vector, Unmatched Tracklet Vector or Remaining Unmatched Tracklet Vector in the Collective Pairing by inserting a corresponding Detected Appearance Vector α_{ndav}(t_{c}) as the first Previous Appearance Vector PA¹in the Tracklet Vector Trⱼ(ø) and deleting the last Previous Appearance Vector PA¹⁰⁰ of the Tracklet Vector Trⱼ(ø);
b) adding to the Tracking Database 24 a new Tracklet Vector whose first Previous Appearance Vector PA¹ includes the Detected Appearance Vector α_{ndav}(t_{c}) whose index does not match that of a Tracklet Vector, Unmatched Tracklet Vector or Remaining Unmatched Tracklet Vector in the Collective Pairing; and
c) deleting from the Tracking Database 24 those Tracklet Vectors Trⱼ(ø) whose ages exceed the maximum historical age.

The method 300 further includes moving to the step 304 for processing a next received video frame.

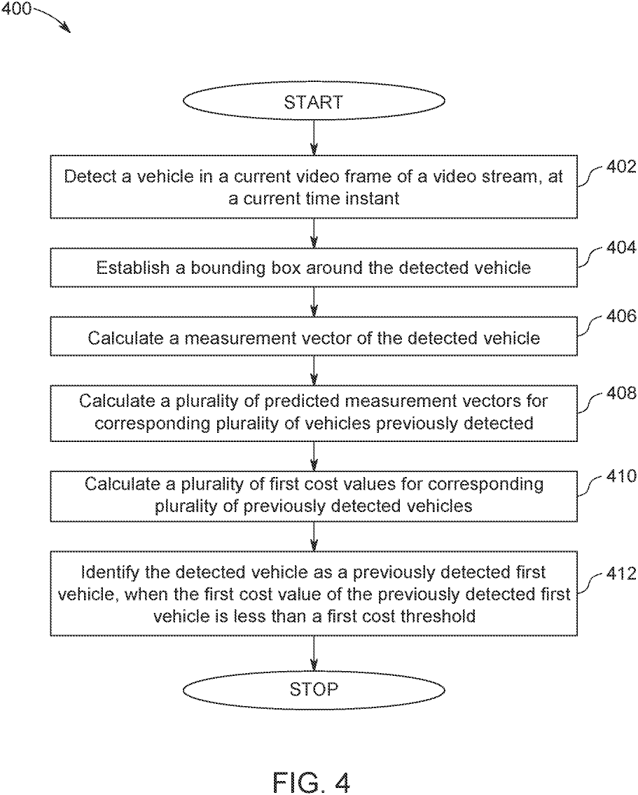

FIG. 4 is a flowchart illustrating a method 400 for tracking and identifying vehicles, in accordance with an embodiment of the present disclosure.

At step 402, the method 400 includes detecting a vehicle in a current video frame of a video stream, at a current time instance. In an embodiment of the present dislcosure, the detector module 10 includes an object detector algorithm configured to receive a video frame or a Concatenated Video Frame and to detect therein the presence of a vehicle. In the present embodiment and use case of a drive-through facility, the object detector algorithm is further configured to apply a classification label to the detected vehicle. The classification label is being one of, for example, a sedan, an SUV, a truck, a cabrio, a minivan, a minibus, a microbus, a motorcycle and a bicycle but is not limited thereto.

At step 404, the method 400 includes establishing a bounding box around the detected vehicle. In an embodiment of the present, the object detector algorithm is further configured to determine the location of the detected vehicle in the video frame or concatenated video frame. At step 406, the method 400 includes calculating a measurement vector of the detected vehicle, the measurement vector including horizontal and vertical locations of the centre of the bounding box at the current time instance.

As disclosed earlier herein, the location of the detected vehicle is represented by the co-ordinates of a bounding box which is configured to enclose the vehicle. The co-ordinates of a bounding box are established with respect to the co-ordinate system of the video frame or Concatenated Video Frame. In particular, the object detector algorithm is configured to receive individual successively captured video frames Fr(τ + iΔt) from the video footage VID, and to process each video frame Fr(τ) to produce details of a set of bounding boxes B(τ) = [b₁(τ),b₂(τ) .....bᵢ(τ))^{T}i ≤ N_{Veh}(τ), where N_{Veh}(τ) is the number of vehicles detected and identified in the video frame Fr(τ) and bᵢ(τ) is the bounding box encompassing an i^{th} vehicle. The details of each bounding box bᵢ(τ) comprise four variables, namely [x,y], h and w, where [x,y] is the co-ordinates of the upper left corner of the bounding box relative to the upper left corner of the video frame (whose coordinates are [0,0]); and h,w are the height and width of the bounding box respectively. Thus, the output from the Detector Module 10 includes one or more Detected Measurement vectors, where each vector includes the co-ordinates of a bounding box enclosing a vehicle detected in the received video frame

At step 408, the method 400 includes calculating a plurality of predicted measurement vectors for corresponding plurality of vehicles previously detected at a plurality of time instances preceding the current time instance. Each predicted measurement vector being calculated based on the current measurement vector and a previous state vector of corresponding previously detected vehicle. In an embodiment of the present disclosure, for the detected vehicle in a current video frame, the State Predictor Module 18 receives a corresponding Detection Measurement vector from the Detector Module 10, and retrieve the Previous State vectors of previously detected vehicles from the Previous State Database 22. The State Predictor Module 18 estimates candidate dynamics of the detected vehicle enclosed by the bounding box whose details are contained in the Detection Measurement vector based on the estimated dynamics of previously detected vehicles (represented by the Previous State vectors retrieved from the Previous State Database 22).

At step 410, the method 400 includes calculating a plurality of first cost values for corresponding plurality of previously detected vehicles, each first cost value being calculated based on a distance between the current measurement vector of the detected vehicle, and a predicted measurement vector of corresponding previously detected vehicle. At step 412, the method 400 includes identifying the detected vehicle as a previously detected first vehicle, when the first cost value of the previously detected first vehicle is less than a first cost threshold.

In an embodiment of the present disclosure, the Matcher Module 20 calculates a distance between the current Measurement vector for the detected vehicle and each predicted Measurement vector. By comparing the distance values calculated from different previously detected vehicles, it is possible to determine which (if any) of the previously detected vehicles most closely matches the current detected vehicle. In other words, this process enables re-identification of detected vehicles.

Modifications to embodiments of the present disclosure described in the foregoing are possible without departing from the scope of the present disclosure as defined by the accompanying claims. Expressions such as “including”, “comprising”, “containing”, “incorporating”, “consisting of”, or “have” that are used herein to describe and claim the present disclosure are intended to be construed in a non-exclusive manner, namely allowing for items, components or elements not explicitly described also to be present. Reference to the singular is also to be construed to relate to the plural.

What is claimed is:

1. A method for tracking and identifying vehicles, the method comprising:
detecting a vehicle in a current video frame of a video stream, at a current time instance;
establishing a bounding box around the detected vehicle;
calculating a measurement vector of the detected vehicle, the measurement vector including horizontal and vertical locations of a centre of the bounding box at the current time instance;
calculating a plurality of predicted measurement vectors for a corresponding plurality of vehicles previously detected at a plurality of time instances preceding the current time instance, each predicted measurement vector being calculated based on a current measurement vector and a previous state vector of a corresponding previously detected vehicle;
calculating a plurality of first cost values for the corresponding plurality of previously detected vehicles, each first cost value being calculated based on a distance between the current measurement vector of the detected vehicle, and a predicted measurement vector of the corresponding previously detected vehicle; and
identifying and storing the detected vehicle as a previously detected first vehicle, when the first cost value of the previously detected first vehicle is less than a first cost threshold.

2. The method of claim 1 further comprising:
establishing an appearance vector for the detected vehicle, the appearance vector including a plurality of appearance attributes of the detected vehicle at the current time instance;
retrieving a plurality of tracklet vectors for corresponding plurality of previously detected vehicles from a database, each tracklet vector including a plurality of previous appearance vectors of corresponding previously detected vehicle at corresponding plurality of time instances preceding the current time instance; and
calculating a plurality of second cost values for a plurality of previous appearance vectors of the plurality of tracklet vectors, wherein each second cost value is being calculated based on a distance between a current appearance vector of the detected vehicle, and a corresponding previous appearance vector.

3. The method of claim 2 further comprising:
establishing a weighted sum of the plurality of first and second cost values; setting an age threshold to a value of one, and a counter to a value of one;
selecting a first tracklet vector from the plurality of tracklet vectors, the selected first tracklet vector having an age equal to the age threshold, wherein the age of the selected first tracklet vector is equal to a number of time instances elapsed between the current time instance, and a time instance at which a previously detected second vehicle of the selected first tracklet vector was last observed;
establishing a first pairing between the detected vehicle and the previously detected second vehicle , based on the weighted sum and a pre-defined cost threshold value;
identifying the detected vehicle as the previously detected second vehicle, based on the first pairing;
increasing the age threshold by one and incrementing the counter by one if the first pairing is not established upon selecting each tracklet vector of an age equal to the age threshold; and
comparing the counter with a maximum counter threshold.

4. The method of claim 3 further comprising:
calculating a third cost value as an intersection over union (IoU) measurement between the current measurement vector of the detected vehicle and a predicted measurement vector of a previously detected third vehicle corresponding to a second tracklet vector of age one when the counter exceeds the maximum counter threshold, wherein the previously detected third vehicle is absent in the first pairing;
establishing a second pairing between the currently detected vehicle and the previously detected third vehicle based on the third cost value; and
identifying the detected vehicle as the previously detected third vehicle, based on the second pairing.

5. The method of claim 4 further comprising establishing a second excluded pair of the detected vehicle and a previously detected fourth vehicle corresponding to a previous appearance vector, that has the second cost value exceeding a second cost threshold.

6. The method of claim 5 further comprising establishing a first excluded pair of the detected vehicle, and a previously detected fifth vehicle that has the first cost value exceeding the first cost threshold.

7. The method of claim 6 further comprising: establishing the first and second pairings based on the first and second excluded pairs.

8. The method of claim 7 further comprising:
updating in the database, the previous measurement vector corresponding to one of: the previously detected second and third vehicles with the current measurement vector, when one of: first and second pairings are established;
adding the current measurement vector as a new previous state vector in the database, when none of first and second pairings are established; and
deleting from the database, a previous state vector that has an age exceeding a maximum historical age.

9. The method of claim 8 further comprising:
updating the database, by replacing a most recent appearance vector of one of: first and second tracklet vectors with the current appearance vector, and deleting corresponding last appearance vector when one of: first and second pairings are established;
adding to the database, a new tracklet vector including the most recent appearance vector as the current appearance vector of the detected vehicle, when none of: first and second pairings are established; and
deleting from the database, a third tracklet vector that has an age exceeding the maximum historical age.

10. A system for tracking and identifying vehicles, the system comprising:
a memory; and
a processor communicatively coupled to the memory, and configured to:
detect a vehicle in a current video frame of a video stream, at a current time instance;
establish a bounding box around the detected vehicle;
calculate a measurement vector of the detected vehicle, the measurement vector including horizontal and vertical locations of a centre of the bounding box at the current time instance;
calculate a plurality of predicted measurement vectors for corresponding plurality of vehicles previously detected at a plurality of time instances preceding the current time instance, each predicted measurement vector being calculated based on a current measurement vector and a previous state vector of corresponding previously detected vehicle;
calculate a plurality of first cost values for the corresponding plurality of previously detected vehicles, each first cost value being calculated based on a distance between the current measurement vector of the detected vehicle, and a predicted measurement vector of corresponding previously detected vehicle; and
identify and store the detected vehicle as a previously detected first vehicle, when the first cost value of the previously detected first vehicle is less than a first cost threshold.

11. The system of claim 10, wherein the processor is further configured to:
establish an appearance vector for the detected vehicle, the appearance vector including a plurality of appearance attributes of the detected vehicle at the current time instance;
retrieve a plurality of tracklet vectors for corresponding plurality of previously detected vehicles from a database, each tracklet vector including a plurality of previous appearance vectors of corresponding previously detected vehicle at corresponding plurality of time instances preceding the current time instance; and
calculate a plurality of second cost values for a plurality of previous appearance vectors of the plurality of tracklet vectors, wherein each second cost value is being calculated based on a distance between a current appearance vector of the detected vehicle, and a corresponding previous appearance vector.

12. The system of claim 11, wherein the processor is further configured to:
establish a weighted sum of the plurality of first and second cost values;
set an age threshold to a value of one, and a counter to a value of one;
select a first tracklet vector from the plurality of tracklet vectors, the selected first tracklet vector having an age equal to the age threshold, wherein the age of the selected first tracklet vector is equal to a number of time instances elapsed between the current time instance, and a time instance at which a previously detected second vehicle of the selected first tracklet vector was last observed;
establish a first pairing between the detected vehicle and the previously detected second vehicle , based on the weighted sum and a pre-defined cost threshold value;
identify the detected vehicle as the previously detected second vehicle, based on the first pairing;
increase the age threshold by one and increment the counter by one if the first pairing is not established upon selecting each tracklet vector of an age equal to the age threshold; and
compare the counter with a maximum counter threshold.

13. The system of claim 12, wherein the processor is further configured to:
calculate a third cost value as an intersection over union (IoU) measurement between the current measurement vector of the detected vehicle and a predicted measurement vector of a previously detected third vehicle corresponding to a second tracklet vector of age one when the counter exceeds the maximum counter threshold, wherein the previously detected third vehicle is absent in the first pairing;
establish a second pairing between the currently detected vehicle and the previously detected third vehicle based on the third cost value; and
identify the detected vehicle as the previously detected third vehicle, based on the second pairing.

14. The system of claim 13, wherein the processor is further configured to: establish a second excluded pair of the detected vehicle and a previously detected fourth vehicle corresponding to a previous appearance vector, that has the second cost value exceeding a second cost threshold.

15. The system of claim 14, wherein the processor is further configured to: establish a first excluded pair of the detected vehicle, and a previously detected fifth vehicle that has the first cost value exceeding the first cost threshold.

16. The system of claim 15, wherein the processor is further configured to: establish the first and second pairings based on the first and second excluded pairs.

17. The system of claim 16, wherein in the memory comprises:
a previous state database storing the plurality of previous state vectors for corresponding plurality of previously detected vehicles, each previous measurement vector being calculated based on a most recent observation of corresponding previously detected vehicle at a time instance preceding the current time instance, wherein each previous state vector includes horizontal and vertical locations of centre of a bounding box, surrounding corresponding previously detected vehicle, scale and aspect ratio of the bounding box, first derivative of the horizontal and vertical locations of the centre of the bounding box, and first derivative of the scale and aspect ratio of the bounding box, and wherein the previous state database is initially populated with previous measurement vectors derived from an initial video frame received at an initial time instance; and
a tracking database storing the plurality of tracklet vectors, wherein the tracking database is initially populated with the current appearance vector of a vehicle detected in an initial video frame, and wherein the tracking database and the previous state database are populated according to the order in which vehicles are detected, such that the ordering of the tracklet vectors in the tracking database matches that of the previous measurement vectors in the previous state database.

18. The system of claim 17, wherein the processor is further configured to:
update in the previous state database, the previous state vector corresponding to one of: the previously detected second and third vehicles with the current measurement vector, when one of: first and second pairings are established;
add the current measurement vector as a new previous state vector in the previous state database, when none of first and second pairings are established; and
delete from the previous state database, a previous state vector that has an age exceeding a maximum historical age.

19. The system of claim 18, wherein the processor is further configured to:
update the tracking database, by replacing a most recent appearance vector of one of: first and second tracklet vectors with the current appearance vector, and deleting corresponding last appearance vector when one of: first and second pairings are established;
add to the tracking database, a new tracklet vector including the current appearance vector of the detected vehicle as the most recent appearance vector, when none of: first and second pairings are established; and
delete from the tracking database, a third tracklet vector that has an age exceeding the maximum historical age.

20. A non-transitory computer readable medium configured to store instructions that when executed by a processor, cause the processor to execute a method to track and identify a vehicle, the method comprising:
detecting a vehicle in a current video frame of a video stream, at a current time instance;
establishing a bounding box around the detected vehicle;
calculating a measurement vector of the detected vehicle, the measurement vector including horizontal and vertical locations of a centre of the bounding box at the current time instance;
calculating a plurality of predicted measurement vectors for corresponding plurality of vehicles previously detected at a plurality of time instances preceding the current time instance, each predicted measurement vector being calculated based on a current measurement vector and a previous state vector of corresponding previously detected vehicle;
calculating a plurality of first cost values for the corresponding plurality of previously detected vehicles, each first cost value being calculated based on a distance between the current measurement vector of the detected vehicle, and a predicted measurement vector of corresponding previously detected vehicle; and
identifying and storing the detected vehicle as a previously detected first vehicle, when the first cost value of the previously detected first vehicle is less than a first cost threshold.
